(19) United States
(12) Patent Application Publication
(10) Pub. No.: US 2019/0017863 A1
(43) Pub. Date: Jan. 17, 2019

(54) MACHINE FOR PROCESSING RECYCLABLE MATERIALS

(71) Applicant: ReFund Solutions, LLC d/b/a ReFund, Brooklyn, NY (US)

(72) Inventors: Jonah E. Saltzman, Brooklyn, NY (US); Justin M. Tedaldi, Tivoli, NY (US); Christopher T. Tan, New York, NY (US); Leo F. Kaupert, Brooklyn, NY (US)

(73) Assignee: ReFund Solutions, LLC d/b/a ReFund, Brooklyn, NY (US)

(21) Appl. No.: 16/035,907

(22) Filed: Jul. 16, 2018

Related U.S. Application Data
(60) Provisional application No. 62/533,366, filed on Jul. 17, 2017.

(51) Int. Cl. G01G 19/414; B65G 69/14; G06Q 20/06; G06Q 10/00

(52) U.S. Cl. CPC G01G 19/414; B65G 69/14; G06Q 2220/00; G06Q 10/30; B65G 2201/02; G06Q 20/065

(57) ABSTRACT

A machine is provided for processing recyclable materials deposited therein. The machine includes an input adapted to receive a plurality of recyclable material objects deposited therein, a sensor system for sensing and distinguishing the type of recyclable material deposited therein, a weighing member for weighing the recyclable material deposited therein, and a crypto-currency dispensing system for dispensing crypto-currency in an amount corresponding to the type of recyclable material deposited therein and the weight of the recyclable material deposited therein.

### CROSS REFERENCE To RELATED APPLICATIONS

The present application claims priority and relates to U.S. Provisional Application 62/533,366, filed on Jul. 17, 2017, the entirety of which is hereby incorporated by reference.

### BACKGROUND OF THE INVENTION

### 1. Field of the Invention

The invention relates generally to a recycling systems, machines, and processes, and more particularly to those that sort various recyclable materials and use crypto-currency as redemption value.

### 2. Description of Related Art

Recycling material waste that would otherwise end up in landfills has become a wide-spread environmental protection policy. Several materials, including various types of plastics, papers, and metals can be recycled and converted from waste into useful articles. As an incentive to recycle such materials, municipalities and other governments and private sector actors provide monetary rewards or reimbursements for recycling fees paid when recyclable products are originally purchased. Recycling centers/retail stores, such as grocery stores, are typical brick and mortar facilities where redemption for recycling of wastes can be done.

Another “facility” for recycling that has become common is recycling processing machines. These machines will accept a certain type of recyclable material, such as aluminum or plastic cans, and disburse a receipt that can be redeemed for money or will simply disburse actual money that equals the redemption value of the recycled material.

Crypto-currencies such as Bitcoin and Ethereum blockchain have become popular monetary forms operating in specialized markets. Blockchain provides an electronic ledger of assets that can be cryptographically protected and tracked to ensure proper title of the asset thus minimizing administrative costs and time otherwise associated with financial transactions.

Accordingly, there is a need in the art for a recycling machine, system and process that applies crypto-currency and material sensing and sorting technologies together.

### SUMMARY OF THE INVENTION

The present invention solves many of the problems of traditional recycling devices and services, as described above. It is an object and advantage of the present invention to provide a recycling system, machine, and process capable of sorting and processing recyclable materials and redeeming the material for equivalent amount of crypto-currency.

It is another object and advantage of the present invention to provide a recycling system, machine, and process that interfaces with digital account to create a digital record representative of redemption value of the recycled material.

It is a further object and advantage of the present invention to provide a recycling system, machine, and process that sorts recyclable material types and generates redemptions in a form of currency that corresponds with the quantity of each material type recycled.

It is yet an added object and advantage of the present invention to provide a recycling system, machine, and process for reading codes embedded in recyclable products and generating redemptions in the form of crypto-currencies that correspond with the coded value.

It is still a further object and advantage of the present invention to provide a market for goods/services that can be purchased using crypto-currencies received from recycling materials made from the same materials as those that were recycled.

Other objects and advantages of the present invention will in part be obvious and in part appear hereinafter.

The present disclosure is directed to a recycling machine, system and process. More particularly, the present disclosure is directed towards application of crypto-currency and recycling machines that can sense and sort material types and generates redemption in the form of a crypto currency that equates to the value of the recycled material.

According to an aspect is a machine is provided for processing recyclable materials deposited therein, comprising: (1) an input adapted to receive a plurality of recyclable material objects deposited therein; (2) a sensor system for sensing and distinguishing the type of recyclable material deposited therein; (3) a weighing member for weighing the recyclable material deposited therein; and (4) a crypto-currency dispensing system for dispensing crypto-currency in an amount corresponding to the type of recyclable material deposited therein and the weight of the recyclable material deposited therein. In general terms, the machine may be configured to determine, for example, if a specific bottle has a cap that is made of a different material. Thus, it will have the ability to mechanically separate through cutting, robotic twisting or some other method, the materials so that the end product of the machine is perfect (or close to perfect) compartments of different types of separated materials (for example PET in one compartment and HDPE in another). As a further example, the machine may be configured to completely separate the gold and copper on a circuit board.

According to an embodiment, the machine further comprises a code scanning system, and the recyclable materials deposited therein further include a scannable code incorporated therein, wherein said scannable code encodes data representative of the recyclable material type and weight. The scanning system can, for example, utilize a barcode if one is visible on the item being recycled. The machine will rotate the item to try and sense/detect the barcode. If a barcode is not visible it will use other methods to determine composition. The machine will have a database of materials to determine what material to which that specific barcode applies.

According to an embodiment the crypto-currency dispensing machine is linked to the code scanning system and is adapted to dispense crypto-currency based upon the encoded data. In addition to being linked to the code scanning system, it may also use other methods of determining the material such as analyzing the spectral characteristics of the plastic if no barcode is visible. The machine is configured to use multiple methods to increase confidence that the item being recycled is a specific material.

According to an embodiment the crypto-currency is distributed in the form of tokens composed of the same material and having the same currency value as the type and weight of the recyclable material deposited therein. In an alternative embodiment, only one type of token is used that will be representative of multiple materials.

According to an embodiment the crypto-currency is distributed electronically to an individual's electronic account (i.e., an electronic “wallet”).

According to an embodiment the machine further comprises a debit card reader and means for encoding a predetermined value of crypto-currency onto a debit card.

According to an embodiment the machine further comprises computer code stored on a non-transient storage medium for communicating redeemed crypto-currency values with an electronic ledger.

According to an embodiment, the machine and software (a version where the machine is on the street and accepts different types of plastic containers and aluminum cans) will use a blockchain based smart contract to enable various parties to pick up the recyclables in a smart efficient way (similar to how different Uber or Lyft drivers pick up a passenger). Because all of the machines are networked and connected, this will enable GPS based locations of certified operators to empty machines that they are close to so that machines are never full and are always emptied in a timely matter.

According to an embodiment, the machine's vision system utilizing cameras will be able to utilize an on-board database to interpret the shape of items. This will facilitate narrowing down the type of material the item is comprised of and help prevent fraud (for instance an arm will be rejected). Fraud in general is something the machine will effectively prevent. All of the systems are designed so that the machine cannot be tricked. Thus, for instance even if somebody stuffs a metal bottle cap into a bottle, the machine will be able to use magnetic sensors to identify this and either reject the bottle or cut the bottle in such a way that it can then be disposed of properly and in such a way that does not harm the machine. Additionally, all systems on the machine will be smart enough to know when certain things break. For example, if a motor is not working, the machine will know that that specific motor is not working and alert certified machine technicians.

According to an embodiment, the software running on the machine will learn over time and all the machines in the network will be able to incorporate this learned knowledge. Learning will encompass how the shapes and sizes of items relate to what material each is made. For instance, a specific container may always be made out of PET rather than LDPE.

According to an embodiment, manufacturers may include special codes that provide the machine information about what materials are in a specific item, thus the machine will be smart enough to read barcodes, QR codes and be re-programmable to read all different types of code (if a code is available to read).

According to an embodiment in a street reverse vending machine, the storage part of the machine that comprises various compartments to store various types of material will sense how full each compartment is. Thus, if there is more PET (for example) than can fit in one compartment, another compartment will be able to robotically subdivide itself by means of a partition so that it can hold both for example PET and LDPE but still have them separate within that compartment. This will enable the machine to maximize the amount of space within the machine and yet still keep all materials separate.

According to an embodiment, the machine will be easily emptied, thus the compartments that store the shredded and compacted materials can be easily removed and replaced.

According to an embodiment, information about the specific user will be recorded in the blockchain along with the time of the transaction, the amount and type of material, location of recycled material.

According to an embodiment, the recycling ecosystem will enable manufacturers to provide information on or in their products or packaging of products that the materials comprised within the product are recyclable. The purchaser of the product will simply need to scan a special code within the item with their smart phone and a transaction will be recorded on the blockchain such that tokens or coins are deposited in that individual's wallet.

According to an embodiment, the debit card itself my additionally take the form of a NFC key fob or specialized payment system. Currently a debit card makes the most sense but the machine will be flexible enough to deposit onto in most cases a smart phone then in other cases a debit card and in yet other cases other forms of hardware that are identifiable (identifiable in the sense that a debit card is unique given the data contained within its magnetic stripe of chip) and can transact payments.

According to an alternative embodiment, the present invention is a machine for processing recyclable materials deposited therein. The machine includes (i) an input adapted to receive a recyclable material object deposited therein; (ii) a conveyor belt assembly configured to transport the recyclable material object from the input to a sensor system and a material compacting system, (a) the sensor system for sensing and distinguishing the type of recyclable material deposited therein, and (b) the material compacting system adapted to destruct the recyclable material object into two or more pieces of the recyclable material object; (iii) a slidable carriage assembly adapted to receive the two or more pieces of the recyclable material object from the material compacting system; and (iv) one or more cartridges adapted to receive the two or more pieces of the recyclable material object from the carriage assembly.

In another embodiment, the present invention is a method for processing recyclable materials. The method comprises the steps of: (i) providing a machine comprising an input, a sensor system, a conveyor belt assembly configured to move a recyclable material object from the input to the sensor system and a material condensing system, a carriage assembly configured to move from alignment with the material condensing system to a position above a cartridge on a bottom surface of the machine, and a crypto-currency dispensing system; (ii) depositing a recyclable material object into the input of the machine; (iii) moving, via the conveyor belt assembly, the recyclable material object to the sensor system; (iv) determining the identity of the recyclable material object; (v) moving, via the conveyor belt assembly, the recyclable material object to the material condensing system; (vi) destructing, via the material condensing system, the recyclable material object into two or more pieces of the recyclable material object; (vii) collecting the two or more pieces of the recyclable material object in the carriage assembly; (viii) positioning the carriage assembly in alignment with the cartridge; and (ix) depositing the two or more pieces of the recyclable material object into the cartridge.

These and other aspects of the invention will be apparent from the embodiments described below.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following description taken in conjunction with the accompanying drawings in which:

FIG. 1 is a high level flow diagram of the system, according to an embodiment;

FIG. 2 is a schematic diagram of a machine, according to an embodiment;

FIG. 3 is a perspective view schematic representation of the internal components of the machine, according to an embodiment;

FIG. 4 is a perspective view schematic representations of the external components of the machine, according to an embodiment;

FIG. 5 is a front view schematic representation of a door and a door actuation mechanism of the machine, according to an embodiment;

FIG. 6 is another front view schematic representation of the door and door actuation mechanism of the machine, according to an embodiment;

FIG. 7 is a side view schematic representation of the door and door actuation mechanism of FIG. 6;

FIG. 8 is a front view schematic representation of a conveyor belt assembly and material compacting system of the machine, according to an embodiment;

FIG. 9A is a front view schematic representation of an object on a conveyor belt of the conveyor belt assembly of FIG. 8;

FIG. 9B is a front view schematic representation of an object in the material compacting system of FIG. 8;

FIG. 9C is a front view schematic representation of an object in the shredder of the material compacting system of FIG. 8;

FIG. 10 is a close-up side perspective view schematic representation of the plate and connected linear actuator of the material compacting system of FIG. 13;

FIG. 11 a close-up top perspective view of the carriage assembly in the machine of FIG. 3;

FIG. 12 is a side perspective view schematic representation of a carriage with doors, according to an embodiment.

FIG. 13 is a side view schematic representation of a motor and gear assembly of the carriage, according to an embodiment;

FIG. 14 is a side perspective view schematic representation of a rail system, according to an embodiment;

FIG. 15 is another side perspective view schematic representation of a rail system, according to an embodiment;

FIG. 16 is a side perspective view schematic representation of a cartridge of the machine, according to an embodiment;

FIG. 17 is a side perspective view schematic representation of a side alignment of a pair of cartridges;

FIG. 18 is a close-up view of one N/S magnet on a side surface of a cartridge, according to an embodiment;

FIG. 19 is a side perspective view schematic representation of a S/N magnet attracted to a N/S magnet, according to an embodiment;

FIG. 20 is a side perspective view schematic representation of a pair of cartridges in a top alignment configuration, according to an embodiment;

FIG. 21 is a side perspective view schematic representation of a cartridge, according to an embodiment;

FIG. 22 is a side view schematic representation of a door actuation mechanism of the cartridge, according to an embodiment;

FIG. 23 is a front view schematic representation of the door actuation mechanism of FIG. 22;

FIG. 24 is a front view schematic representation of the top of the cartridge, according to an embodiment;

FIG. 25 is a front view schematic representation of magnets and magnetic-sensing sensors for the doors of the cartridge, according to an embodiment;

FIG. 26 is a front view schematic representation of the door actuating mechanism, according to an alternative embodiment;

FIG. 27 is a front view schematic representation of the door actuating mechanism of FIG. 26 with the shafts between the first and second ends of the shaft path;

FIG. 28 is a close-up front view schematic representation of a flat portion of one shaft of the door actuating mechanism of FIG. 26;

FIG. 29 is a side view schematic representation of the doors of the cartridge in the open position, according to an embodiment;

FIG. 30 is a side perspective view schematic representation of a locking mechanism of the cartridge, according to an embodiment;

FIG. 31 is a front view schematic representation of the cartridge above an alignment feature of the base of the machine, according to an embodiment;

FIG. 32 is a side view schematic representation of the first locking feature of the locking mechanism of the cartridges, according to an embodiment;

FIG. 33 is a side view schematic representation of the second locking feature of the locking mechanism of the cartridges, according to an embodiment;

FIG. 34 is a front view schematic representation of the carriage on a rail of the rail system above the one or more cartridges, according to an embodiment;

FIG. 35 is a side view schematic representation of the carriage adjacent a stack of divider plates, according to an embodiment;

FIG. 36 is a top perspective view schematic representation of a divider plate, according to an embodiment;

FIG. 37 is a side view schematic representation of a divider plate, according to an embodiment;

FIG. 38 is a side view schematic representation of the carriage inserting a divider plate into a cartridge, according to an embodiment;

FIG. 39 is a top perspective view schematic representation of the interior surfaces of the cartridge, according to an embodiment;

FIG. 40A is a front view schematic representation of a top-to-bottom alignment of a pair of cartridges, according to an embodiment;

FIG. 40B is a front view schematic representation of a side-by-side alignment of a pair of cartridges, according to an embodiment;

FIG. 40C is a front view schematic representation of a front-to-back alignment of a pair of cartridges, according to an embodiment;

FIG. 40D is a front perspective view schematic representation of a variety of alignments of five cartridges, according to an embodiment;

FIG. 41 is a side view schematic representation of cartridge with an electrical connector on a side surface, according to an embodiment;

FIG. 42 is a top view schematic representation of cartridge with an electrical connector on a top surface, according to an embodiment;

FIG. 43 is a bottom view schematic representation of cartridge with an electrical connector on a bottom surface, according to an embodiment;

FIG. 44 is a close-up side view of the cartridge at the bottom surface of the machine, according to the embodiment;

FIG. 45 is a schematic diagram of data flow in the system, according to an embodiment;

FIG. 46 is a front perspective view schematic representation of the machine with the door in the closed position, according to an embodiment;

FIG. 47 is a front perspective view schematic representation of the machine with the door in the open position, according to an embodiment;

FIG. 48 is a side view schematic representation of the safety light curtain, according to an embodiment;

FIG. 49 is a side view schematic representation of internal components of the machine, according to an embodiment;

FIG. 50 is a front view schematic representation of the machine vision cameras in the machine, according to an embodiment;

FIG. 51 a top view schematic representation of the machine vision cameras of FIG. 50;

FIG. 52 is a perspective side view schematic representation of the conveyor belt assembly, according to an embodiment;

FIG. 53 is a side view schematic representation of an object on the conveyor belt, according to an embodiment;

FIG. 54 is a front view schematic representation of the color change of the light source in the entrance of the door of the machine, according to an embodiment;

FIG. 55 is a front view schematic representation of the object in the material compacting system, according to an embodiment;

FIG. 56 is a front perspective view schematic representation of the object in the material compacting system, according to an embodiment;

FIG. 57 is a front perspective view schematic representation of the doors of the carriage between the closed position and the open position, according to an embodiment;

FIG. 58 is a front view schematic representation of a carriage positioned above a select cartridge, according to an embodiment;

FIG. 59 is a close-up front view schematic representation of a carriage emptying pieces of an object into a select cartridge, according to an embodiment;

FIG. 60, is a front view schematic representation of a graphical user interface illustrative of a smartphone/computing device application, according to an embodiment;

FIG. 61A is a front view schematic representation of a machine, according to an embodiment;

FIG. 61B is a side perspective view schematic representation of a machine, according to an embodiment;

FIG. 61C is another side perspective view schematic representation of a machine, according to an embodiment;

FIG. 61D is yet another side perspective view schematic representation of a machine, according to an embodiment;

FIG. 62A is a side perspective view schematic representation of a machine, according to an embodiment;

FIG. 62B is another side perspective view schematic representation of a machine, according to an embodiment;

FIG. 62C is an additional side perspective view schematic representation of a machine, according to an embodiment;

FIG. 62D is yet another side perspective view schematic representation of a machine, according to an embodiment;

FIG. 63A is a top perspective view schematic representation of a machine, according to an embodiment;

FIG. 63B is a side perspective view schematic representation of a machine, according to an embodiment;

FIG. 63C is another side perspective view schematic representation of a machine, according to an embodiment;

FIG. 64A is a side perspective view schematic representation of a machine, according to an embodiment;

FIG. 64B is a top perspective view schematic representation of a machine, according to an embodiment;

FIG. 64C is another top perspective view schematic representation of a machine, according to an embodiment;

FIG. 65A is a side perspective view schematic representation of a machine, according to an embodiment; and

FIG. 65B is a top perspective view schematic representation of a machine, according to an embodiment.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

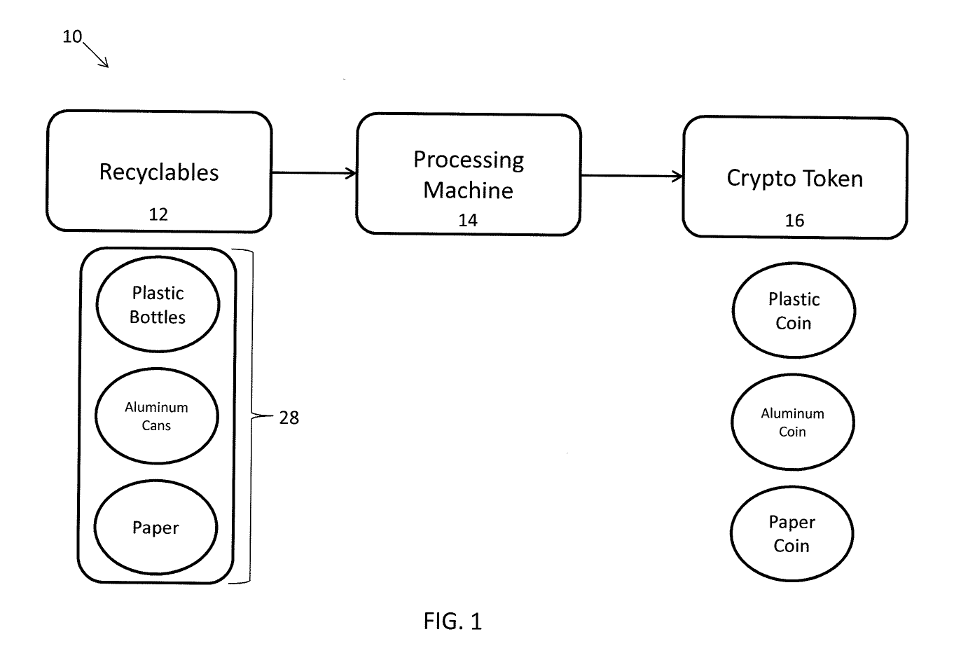

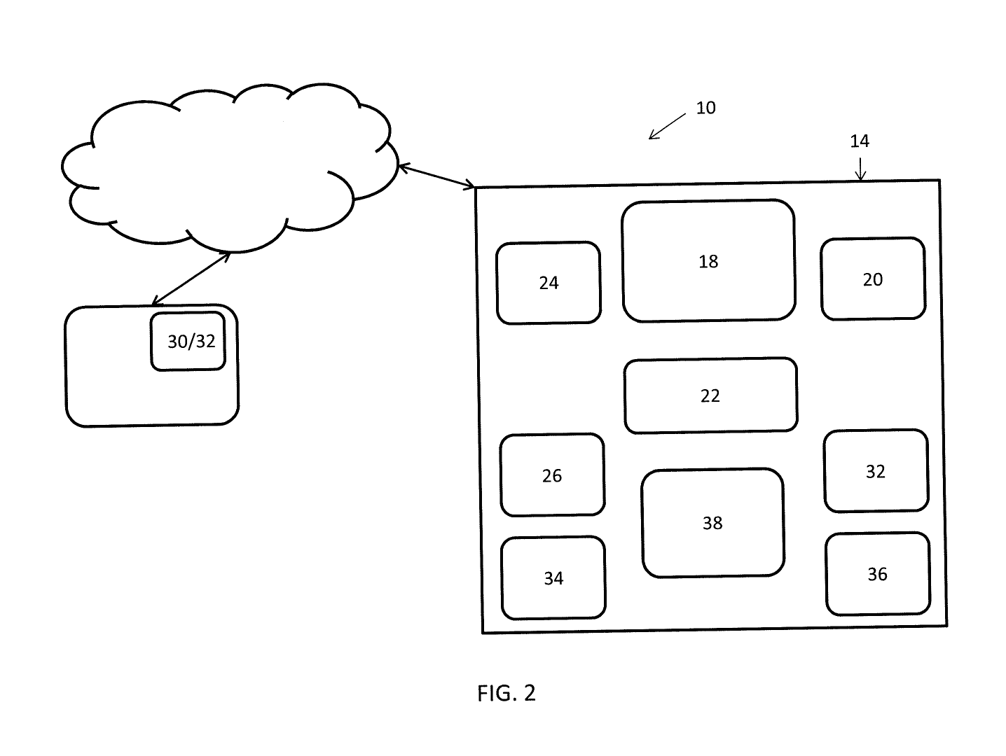

Referring to FIG. 1, in one embodiment, is a system 10 for processing recyclable materials 12 in a machine 14 for redemption of crypto-currency 16. Referring to FIG. 2, machine 14 comprises an input 18 adapted to receive a plurality of recyclable material objects 12 deposited therein; a first sensor system 20 for sensing and distinguishing the type of recyclable material objects 12 deposited therein; a weighing member 22 for weighing the recyclable material 12 deposited therein; and a crypto-currency dispensing system 24 for dispensing crypto-currency 16 in an amount corresponding to the type of recyclable material 12 deposited therein and the weight of the recyclable material 12 deposited therein. Machine 14 further comprises a code scanning system 26, and the recyclable materials 12 deposited therein further include a scannable code 28 (FIG. 1) incorporated therein, wherein said scannable code 28 encodes data representative of the recyclable material 12 type and weight. The crypto-currency dispensing machine 14 is linked to the code scanning system 26 and is adapted to dispense crypto-currency 16 based upon said encoded data. The crypto-currency 16 is distributed in the form of tokens, for example, composed of the same material and having the same currency value as the type and weight of the recyclable material 12 deposited therein. Alternatively, crypto-currency 16 is distributed electronically to an individual's electronic account 30/electronic ledger 30′ (e.g., Bitcoin and/or Ethereum blockchain). Machine 14 further comprises computer code stored on a non-transient storage medium 32 for communicating redeemed crypto-currency values with an electronic ledger 30. The machine 14 further comprises a second sensor system 34 for determining when the machine 14 is full of recycled material 12. The machine 14 further comprises a third sensor system 36 for determining when the machine 14 is broken. The machine 14 further comprises a material compacting system 38 for reducing the volume of recycled material 12 deposited therein.

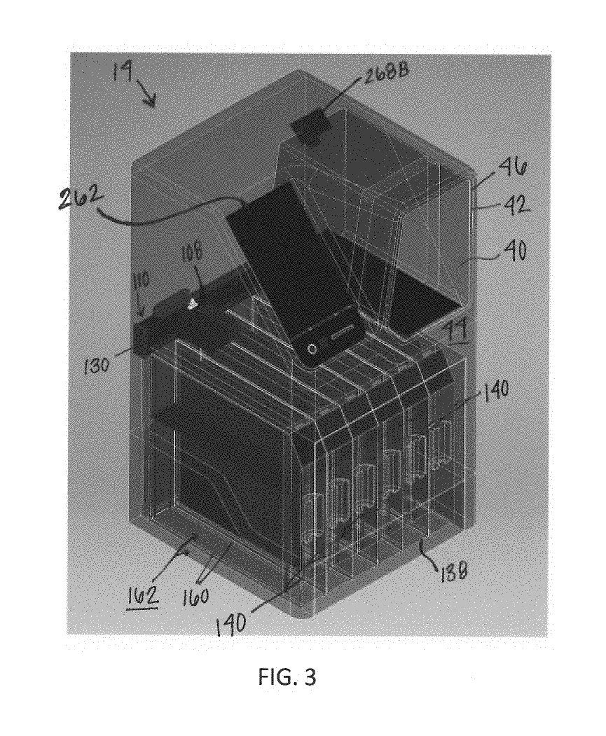

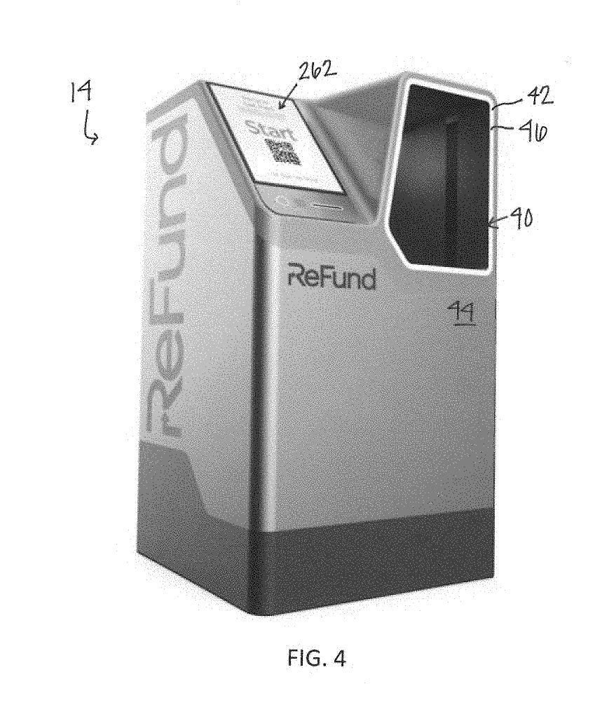

Referring now to FIGS. 3-4, there are shown perspective views schematic representations of the internal and external components of the machine 14, according to an embodiment. In the depicted embodiment, the machine 14 comprises a door 40 with an entrance 42. The door 40 of the machine 14 provides an entry and deposit location for the user to insert a recyclable material object 12 into the machine 14. In the depicted embodiment, the door 40 and the surrounding entrance 42 are located on the front surface 44 of the machine 14. In one embodiment, the entrance 42 surrounds the perimeter of the door 40 and comprises a light source 46 (e.g., LED). The door 40 is actuatable to move between an open position and a closed position. In the open position, the user may place the object 12 into the machine 14 and in the closed position, the door 14 obstructs placement of the object 12 into the machine 14. In one embodiment, in the closed position, the door 40 is flush with the front surface 44 of the machine 14.

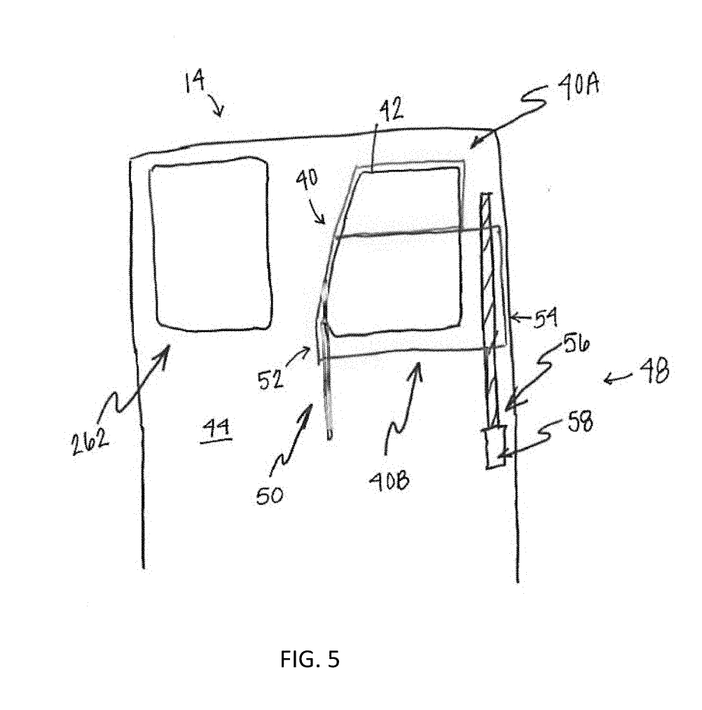

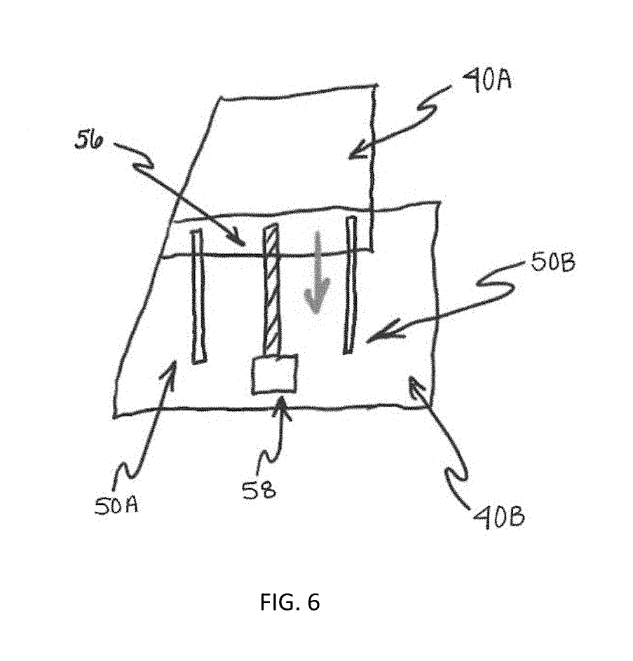

Turning now to FIG. 5, there is shown a front view schematic representation of the door 40 and a door actuation mechanism 48, according to an embodiment. In the depicted embodiment, the door 40 comprises a first piece 40A and a second piece 40B. In the closed position, the first piece 40A abuts or is otherwise adjacent to the second piece 40B, as shown in FIG. 5. As shown, the second piece 40B is slidably connected to a rail 50 on a first side 52 of the second piece 40A and a lead screw 56 on a second side 54 of the second piece 40B. However, alternative configurations of the positioning of the lead screw 56 and rail 50 are contemplated. Further, two or more rails 50 may be used to facilitate sliding of either piece 40A, 40B (FIG. 6). As shown in FIG. 5, the lead screw 46 is operatively coupled to a motor 58.

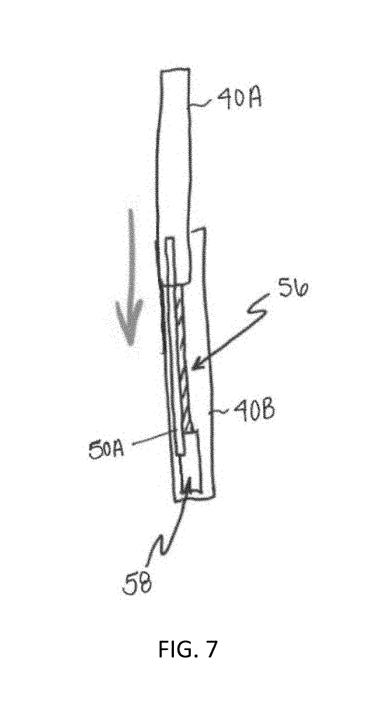

As shown in FIG. 6, the lead screw 56 and the motor 58 are operatively, internally integrated into the second piece 40B. In such embodiment, a pair of spaced rails 50A, 50B extend between and are slidably connected to the first piece 40A and the second piece 40B. The first piece 40A slides along the rails 50A, 50B toward the motor 58 connected to the second piece 40B. A side view of the doors 40A, 40B and door actuating mechanism 48 of FIG. 6 is shown in FIG. 7. In the depicted embodiment, the first piece 40A is show moving along the rail 50A toward the motor 48 on the second piece 40B.

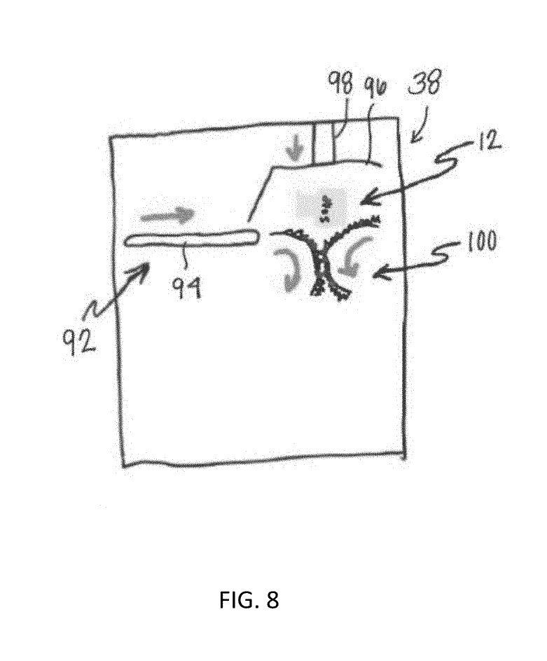

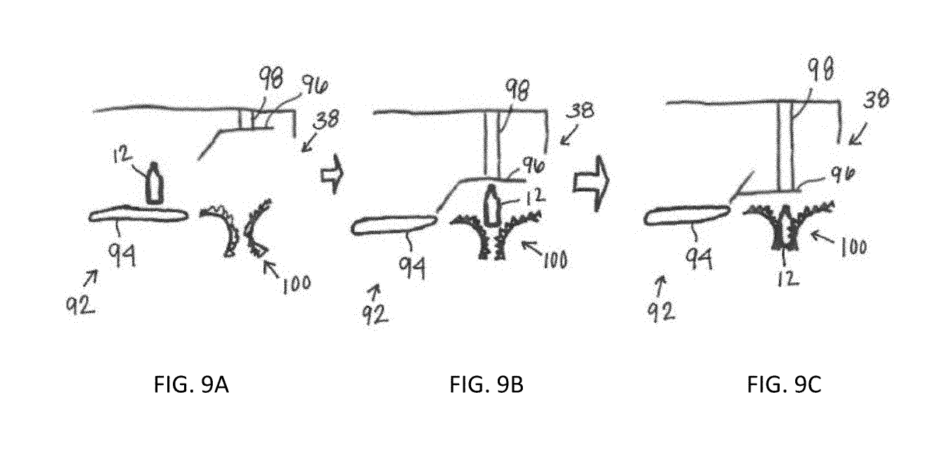

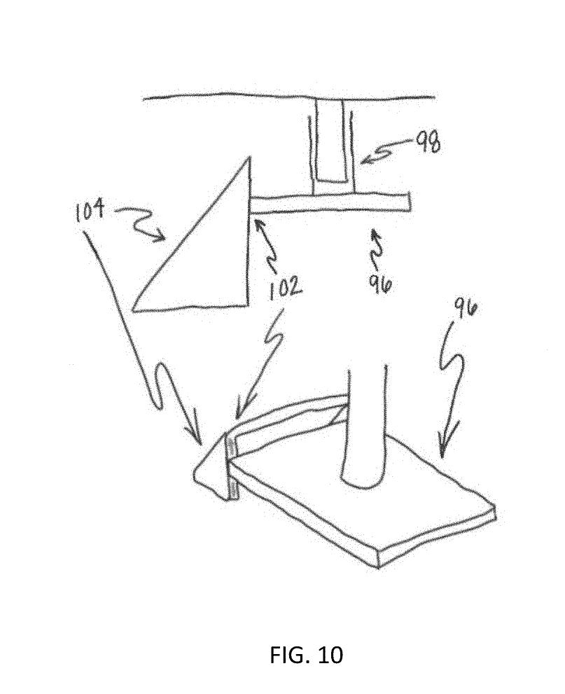

Turning now to FIGS. 8-10, there are shown various views schematic representations of a conveyor belt assembly 92 and the material compacting system 38 of the machine 14. After an object 12 is placed through the door 40 of the machine 14, the conveyor belt assembly 92 the deposited object 12 toward material compacting system 38, which shreds, crushes, or otherwise break-down the object 12. As shown in FIG. 8, the conveyor belt assembly 92 comprises a conveyor belt 94 which moves the object 12 to the material compacting system 38, which is in the open position, as shown in FIG. 9A. The material compacting system 38 comprises a plate 96 connected to a linear actuator 98 (shown in FIG. 10). With the object 12 in the material compacting system 38, which is in the open position, the plate 96 is moved toward the object 12 via the connected linear actuator 98, as shown in FIG. 9B. In the closed position, shown in FIG. 9C, the plate 96 is completely extended and the object 12 is within a shredder 100 (or other similar crushing or destruction device).

FIG. 10 shows a close-up side perspective view schematic representation of the plate 96 and connected linear actuator 98 of the material compacting system 38. As shown, the plate 96 is slidably connected to one or more rails 102 on a shield cover 104 of the material compacting system 38. In the depicted embodiment, the shield cover 104 is a hollow triangular feature with rails 102 on opposing side edges 106. As the plate 96 moves from the open position to the closed position, the plate 96 slides along the rails 102 of the shield cover 104. Thus, when the shield cover 104 contacts, abuts, or is otherwise adjacent to the conveyor belt 94, as shown in FIG. 9B, the plate 96 can continue to slide within the rails 102 of the shield cover 104 to achieve the fully extended and closed position. The purpose of the shield cover 104 is to prevent pieces of the object 12 from exiting or from being propelled out of the machine 14. Thus, the shield cover 104 is a safety mechanism to protect a user from debris resulting from the destruction and breakdown of the object 12.

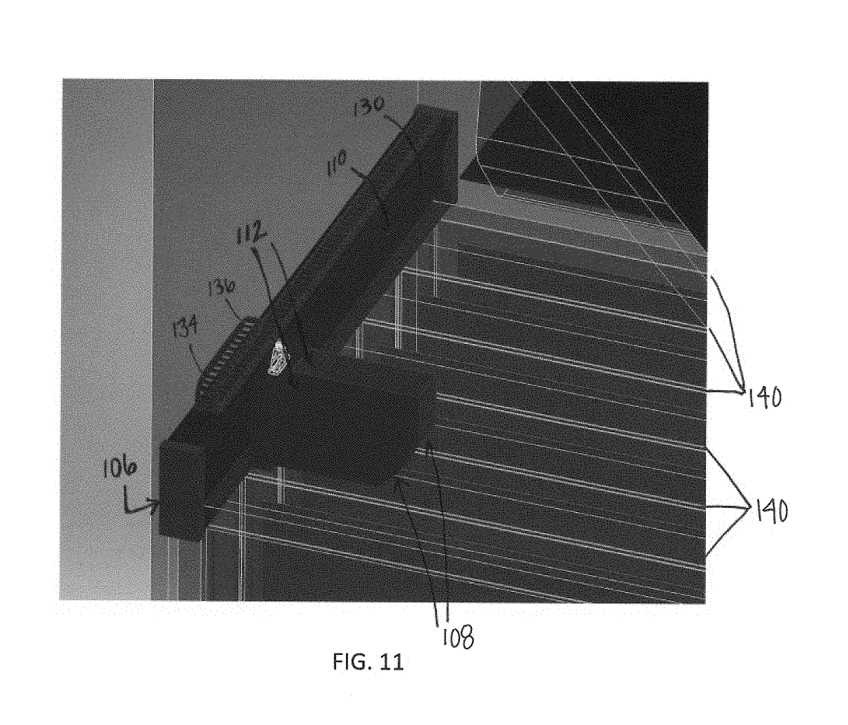

Turning now to FIG. 11, there is shown a close-up top perspective view of the carriage assembly 106 in the machine 14 of FIG. 3. The carriage assembly 106 catches or otherwise receives the pieces of the broken down object 12 from the material compacting system 38. As shown in FIG. 11, the carriage assembly 106 comprises one or more carriages 108, which move along a rail system 110 within the machine 14. In the depicted embodiment, the carriages 108 comprise an open end 112 to receive the pieces of the object 12 from the material compacting system 38.

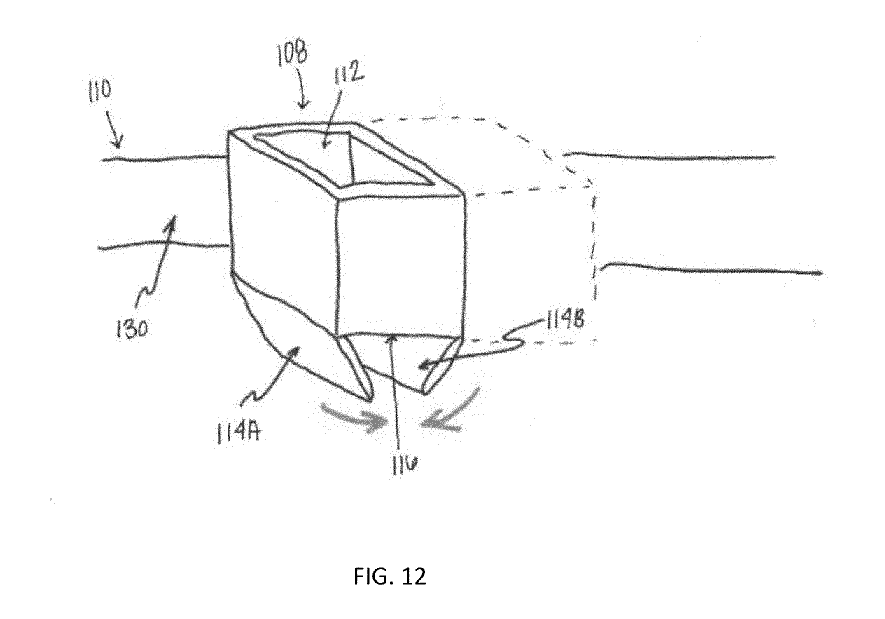

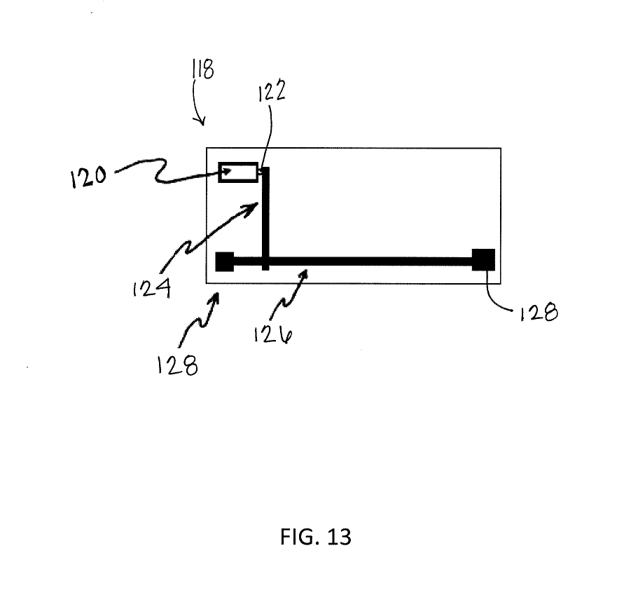

Turning now to FIG. 12, there is shown a side perspective view schematic representation of a carriage 108 with doors 114A, 114B, according to an embodiment. As shown in FIG. 12, the doors 114A, 114B are located at a bottom surface 116 of a carriage 108. In the depicted embodiment, the doors 114A, 114B on the bottom surface 116 of the carriage 108 are actuatable using a similar motor and gear assembly 118, as shown in FIG. 13.

Referring now to FIG. 13, there is shown a side view schematic representation of the motor and gear assembly 118, according to an embodiment. In the depicted embodiment, the motor and gear assembly 118 includes a gear motor 120, which engages and rotates a first gear 122. The first gear 122 is connected to a first belt 124, which is connected to a first shaft 126. Rotation of the first gear 122 by the gear motor 120 causes the first belt 124 to rotate, thereby rotating the connected first shaft 126 between a first pair of bearings 128. The first shaft 126 is rigidly connected to a first door 114A and rotation of the first shaft 126 causes the first door 114A to either rotate to an open position or rotate to a closed position. Rotation of the first gear 122 by the gear motor 120 also causes rotation of a second belt and a second shaft (between a second pair of bearings) (all not shown). The second shaft (not shown) is rigidly connected to the second door 114B and rotation of the second shaft (not shown) causes the second door 114B to either rotate to an open position or rotate to a closed position.

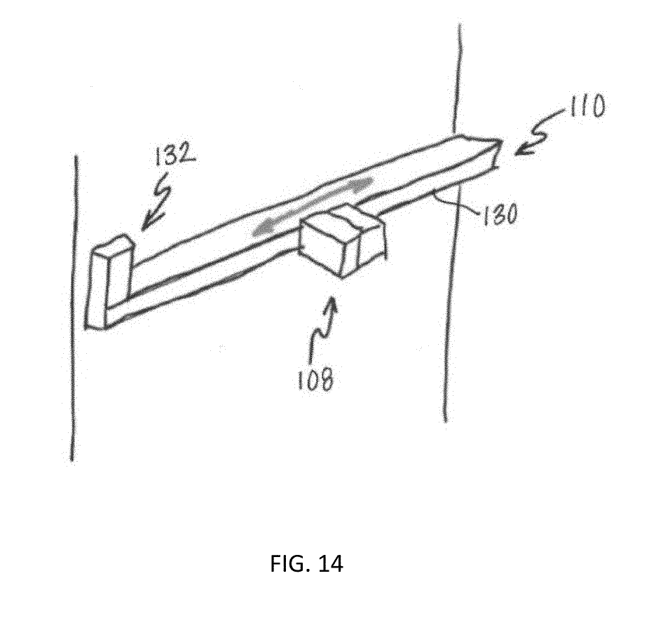

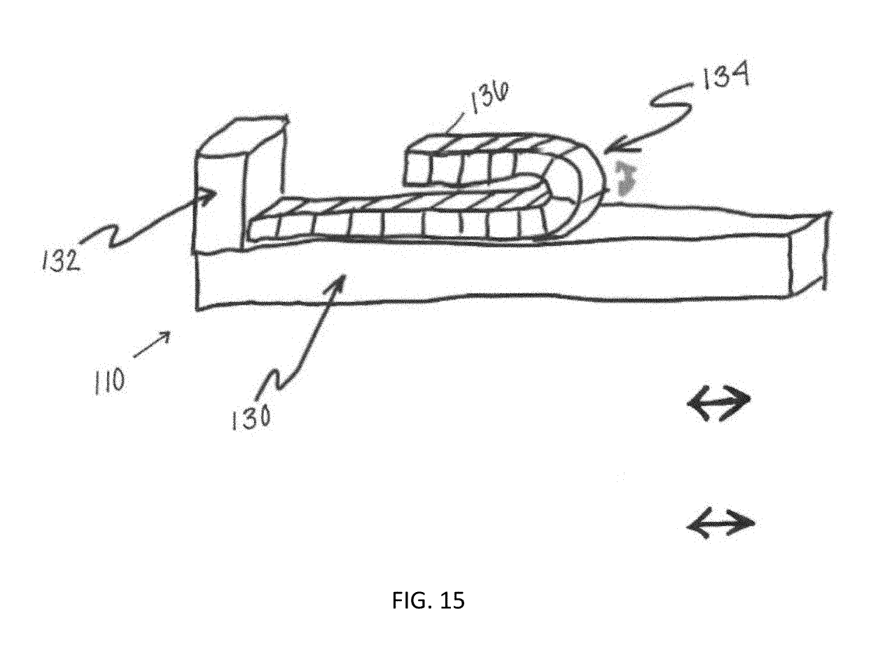

Turning now to FIGS. 14-15, there are shown side perspective views schematic representations of the rail system 110, according to an embodiment. As shown in FIG. 14, the rail system 110 comprises the rail 130 integrated with a gear motor 132 (similar to a Parker 404LXR) to move one or more carriages 108 along the rail 130. As shown in FIG. 15, the rail system 110 comprises a cable 134 fixed to the gear motor 132 and extending along the rail 130. A free end 136 of the cable 134 is rotatable, as shown in FIG. 15. In addition, the rail system 110 also comprises an integrated encoder (not shown) for determining and relaying position information. For example, the integrated encoder can detect and relay information regarding the position of the one or more carriages 108 along the rail 130. In order to organize the pieces of the object 12 into one or more categories (e.g., based on the type of recycled material, such as plastic, paper, and aluminum), the carriage 108 is slidably moved along the rail 130 via the gear motor 132.

Turning briefly back to FIGS. 3 and 11, the one or more carriages 108 move along the rail 130 in the machine 14 to categorize and sort deposited pieces of the object 12. As the object 12 is shredded or otherwise broken-down in the material compacting system 38, the pieces of the object 12 are funneled or otherwise emptied into one or more carriages 108. The carriages 108 move along the rail 130 to sort and dispense the pieces of the object 12 into one or more cartridges 140. In FIGS. 3 and 11, the cartridges 140 are aligned within a base 138 of the machine 14. The rail system 110 is located or otherwise positioned above the one or more cartridges 140 such that the one or more carriages 108 may move along the rail 130 of the rail system 110 and deposit the contained pieces of the object 12 into an appropriate cartridge 140.

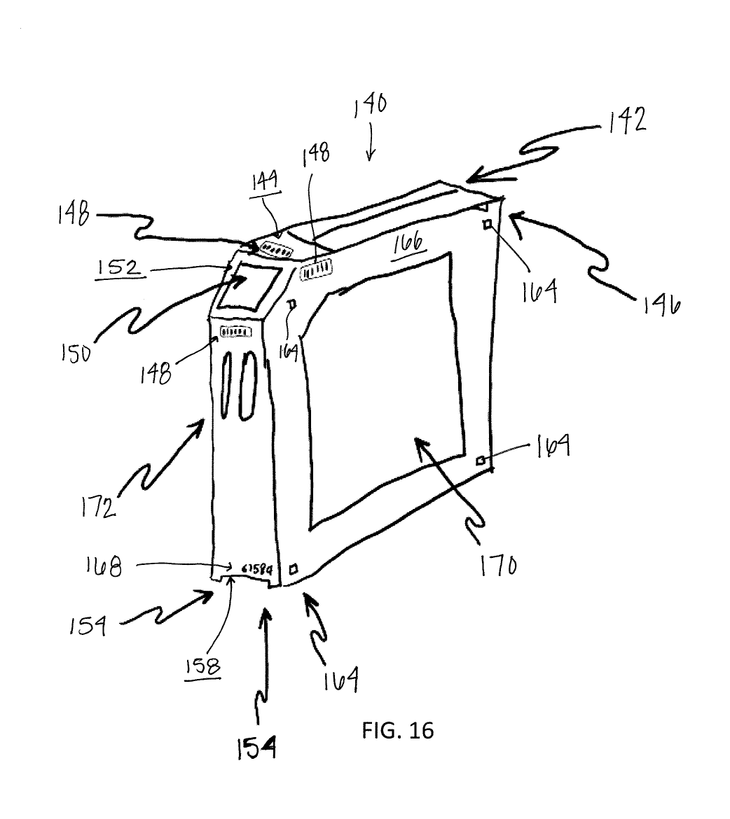

Referring now to FIG. 16, there is shown a side perspective view schematic representation of a cartridge 140 of the machine 14, according to an embodiment. As shown in FIG. 16, the cartridge 140 is generally rectangular; however, any other suitable configuration may be used. The cartridge 140 includes doors 142 on its top surface 144. In the depicted embodiment, the doors 142 are operatively connected to a locking mechanism 146 for selectively securing the door 142 in a locked or unlocked configuration. The cartridge 140 also comprises one or more electrical connectors 148. In FIG. 16, an electrical connector 148 is located or otherwise positioned on the top surface 144 of the cartridge 140 adjacent the doors 142. Electrical connectors 148 may also be located or otherwise positioned on the remaining front surface, side surfaces, bottom surface, or back surface of the cartridge 140, as shown in FIG. 16. The electrical connectors 148 permit data transfer between one or more cartridges 140 when they are in alignment (e.g., side alignment or top alignment)

Still referring to FIG. 16, the cartridge 140 also includes a display screen 150, such as an E-ink screen. In the depicted embodiment, the screen 150 is on a front surface 152 of the cartridge 140. For the purposes of both placing and securing the cartridge 140 within the base 138 of the machine 14, the cartridge 140 includes a pair of alignment rails 154. In the depicted embodiment, the alignment rails 154 extend from opposing edges 156 on a bottom surface 158 of the cartridge 140. The alignment rails 154 permit the cartridge 140 to slide into tracks 160 on a bottom interior surface 162 at the base 138 of the machine 14 (shown in FIG. 3). In the embodiment shown in FIG. 16, the cartridge 140 may also include one or more magnets 164. Also, in the embodiment shown in FIG. 16, the magnets 164 are located or otherwise positioned on a side surface 166 of the cartridge 140.

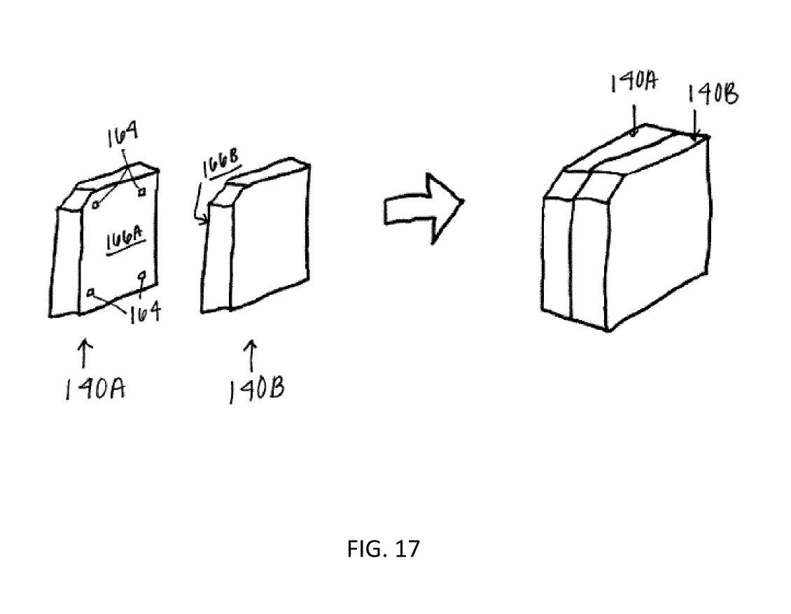

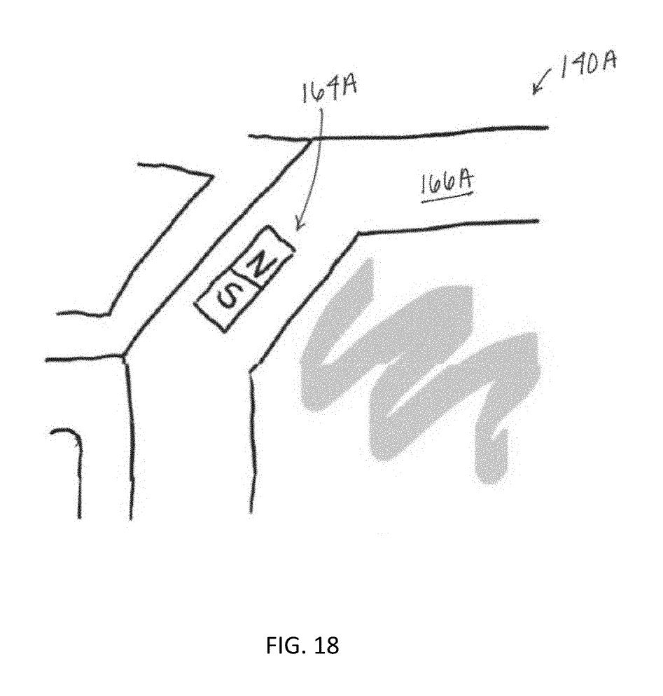

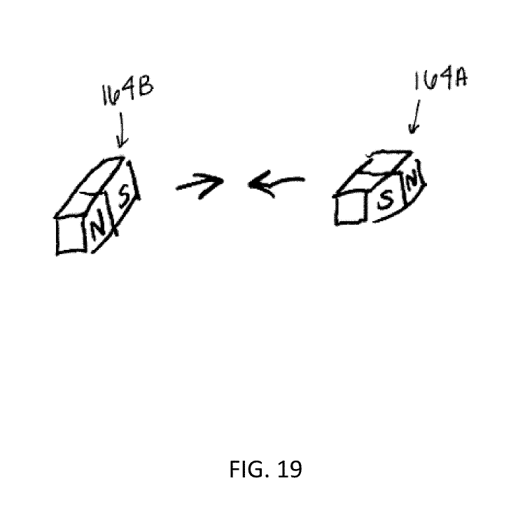

Turning now to FIGS. 17-20, there are shown various views of magnets 164 of the cartridges 140 and magnetic alignment of the cartridges 140, according to one or more embodiments. The magnets 164 on a first side surface 166A of a first cartridge 140A are magnetically attracted to the magnets 164 on a second side surface 166B of a second cartridge 140B, as shown in FIG. 17. In one embodiment, each cartridge 140A, 140B comprises eight N/S magnets 164. FIG. 18 shows a close-up view of one N/S magnet 164A on a side surface 166A of cartridge 140. The N/S magnet 164A shown in FIG. 18 has the North side of the magnet 164A as the top-most portion of the magnet 164A. On the second side surface (not shown) of the cartridge 140, there is an opposing S/N magnet 164B with the South side of the magnet 164B as the top-most portion of the magnet 164B. This configuration ensures that a first side surface 166A of a first cartridge 140A will align and magnetically attract a second side surface 166B of a second cartridge 140B, as shown in FIG. 19. The magnetic force of the magnets 164A, 164B must be strong enough for alignment but weak enough such that the cartridges 140A, 140B may be separated when the user pulls the cartridges 140A, 140B in opposing directions.

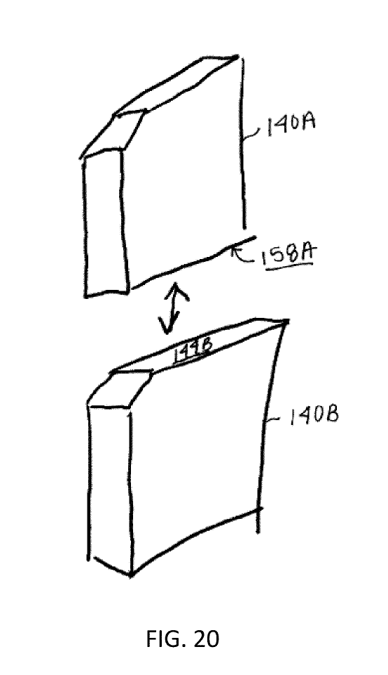

Referring briefly to FIG. 20, there is shown a side perspective view schematic representation of a pair of cartridges 140A, 140B in a top alignment configuration, according to an embodiment. In the depicted embodiment, the cartridges 140A, 140B may be stacked on top of one another such that the bottom surface 158A of a first cartridge 140A abuts or engages the top surface 144B of a second cartridge 140B. Due to the size of the machine 14, the cartridges 140A, 140B can only be stacked outside the machine 14. Stacking the cartridges 140A, 140B allows for a transfer of data between the first cartridge 140A and the second cartridge 140B due to the electrical connector 148 on the top surface 144 of the second cartridge 140B (as shown in FIG. 16).

Referring back to FIG. 16, the depicted embodiment also shows identification and portability features of the cartridge 140. In the depicted embodiment, the cartridge 140 comprises an identifier 168 on a front surface 152 of the cartridge 140. The identifier 168 can be a series of numbers, as shown, or any other symbol or unique arrangement of symbols. In addition to an identifier 168, the cartridge 140 may also include a visibility window 170 on a side (or side surface 166) of the cartridge 140, as shown in FIG. 16. The visibility window 170 is composed of a translucent or semi-translucent material which permits a user to see the contents of the cartridge 140 through the visibility window 170. For transportation of the cartridge 140, the cartridge 140 can include a handle 172. Although the handle 172 is shown on the front surface 152 of the cartridge 140 in FIG. 16, the handle 172 can be located or otherwise positioned anywhere on the cartridge 140. The handle 172 may be formed within the cartridge 140 (e.g., through carving, as shown in FIG. 16) or as an attachment to the cartridge 140.

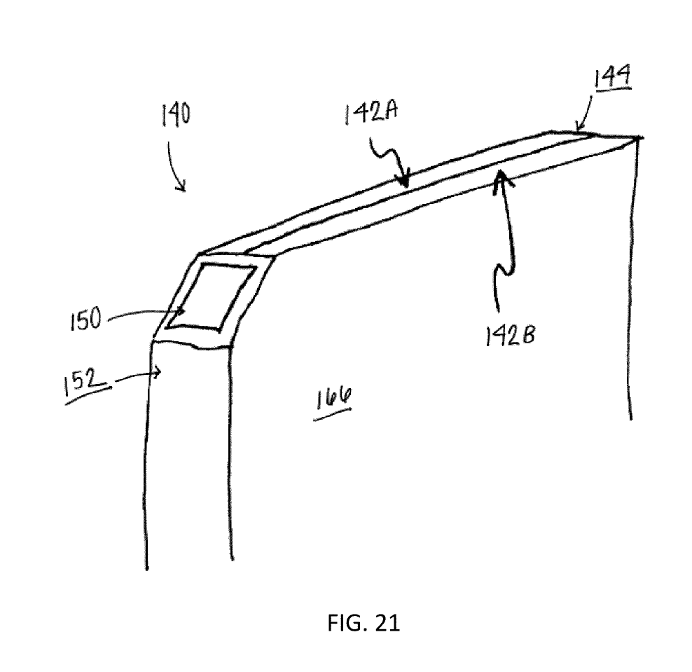

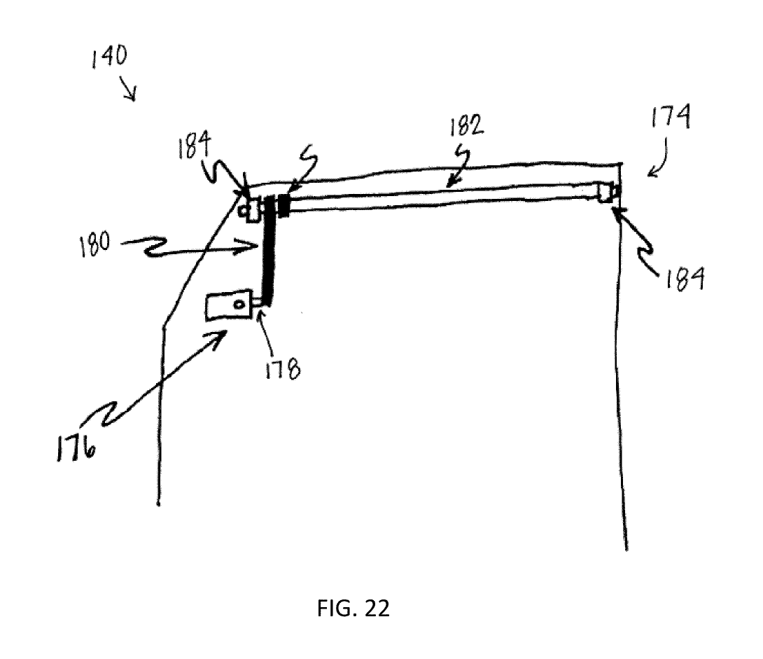

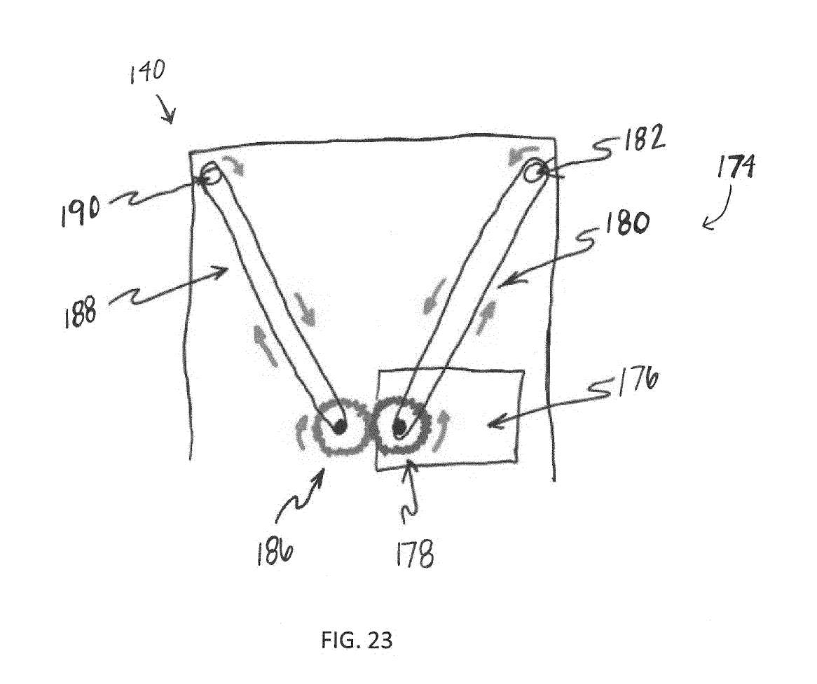

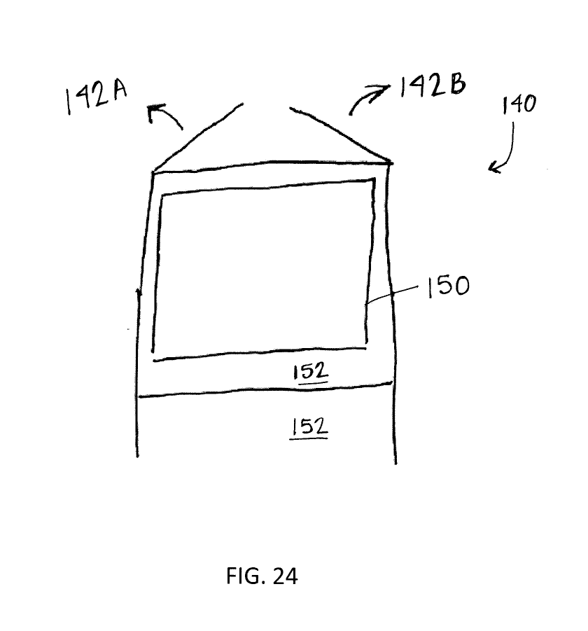

Turning now to FIGS. 21-29, there are shown various views schematic representations of the doors 142 and door actuation mechanism 174 of the cartridge 140 in the closed position, according to an embodiment. As shown in FIG. 22, the cartridge 140 comprises a first and second door 142A, 142B on the top surface 144 of the cartridge 140. FIGS. 22-24 depict an embodiment of the door actuation mechanism 174 within the cartridge 140. As shown in FIG. 23, the cartridge 140 comprises a gear motor 176 which rotates a connected mating first gear 178. The mating first gear 178 rotates a first belt 180, which is connected thereto. The first belt 180 is secured around a first shaft 182, which extends a length of cartridge 140 between a first pair of bearings 184, as shown in FIG. 22. Rotation of the mating first gear 178 also rotates an adjacent and coupled second gear 186. The second gear 186 rotates a second belt 188, which is connected thereto. The second belt 188 is secured around a second shaft 190. The first and second shafts 182, 190 are rigidly connected to the first and second doors 142A, 142B, respectively. Rotation of the first and second shafts 182, 190 rotate the first and second doors 142A, 142B in opposing direction to an open position, as shown in FIG. 24.

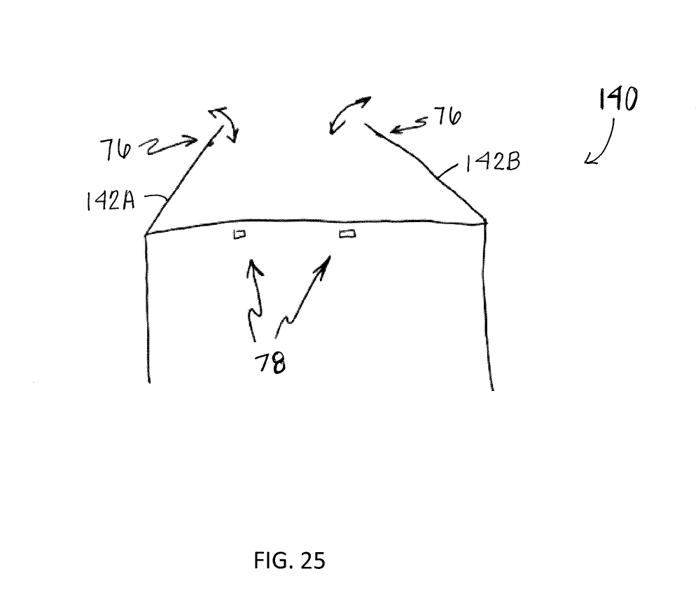

Referring now to FIG. 25, there is shown a front view schematic representation of magnets and magnetic-sensing sensors for the doors of the cartridge, according to an embodiment. As shown, the doors 142A, 142B also comprise one or more small magnets 76 and the machine 14 comprises one or more magnet-sensing sensors 78 (e.g., Hall sensors) at a location adjacent the doors 142A, 142B. Approaching the open position, as shown in FIG. 25, the doors 142A, 142B and the magnets 76 are at a distance or out of sensing range from the magnet-sensing sensors 78. In the closed position (not shown), the doors 142A, 142B are closed and the magnets 76 are approximately aligned or adjacent the sensors 78. Thus, the sensors 78 are able to detect whether the doors 142A, 142B are in or approaching the open position (in FIG. 25) or in the closed configuration (not shown).

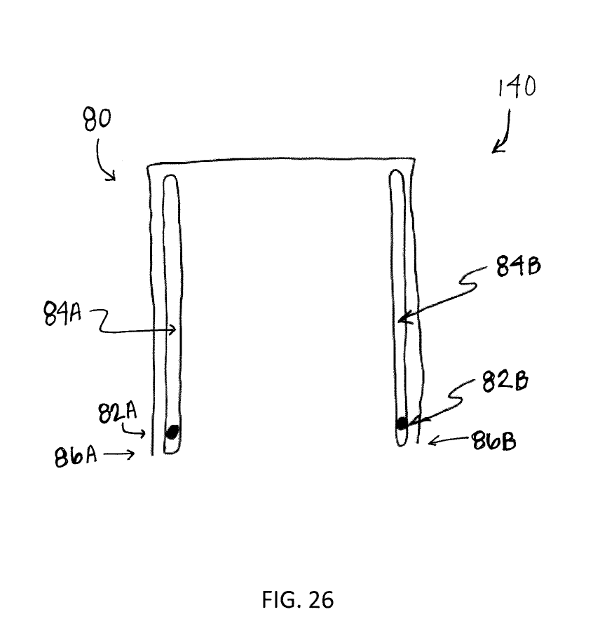

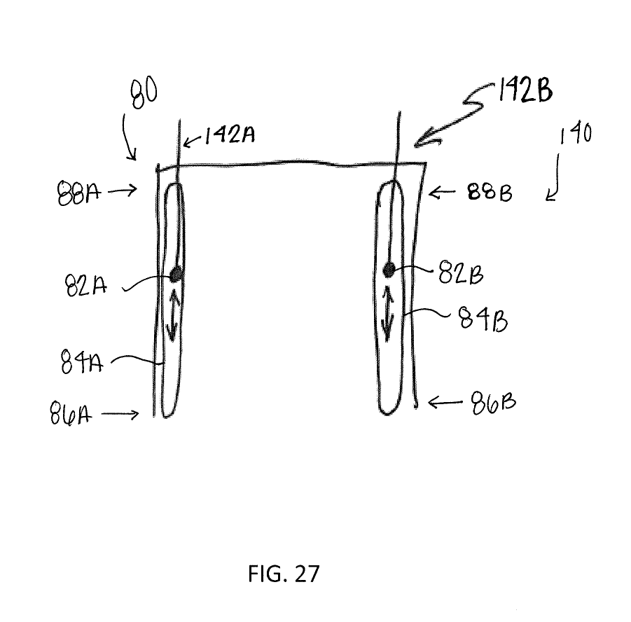

Turning now to FIG. 26, there is shown a front view schematic representation of the door actuating mechanism 174, according to an alternative embodiment. The door actuating mechanism 174 shown in FIG. 26 is a non-motor mechanism 80. By minimizing the number of moving parts actuated internally within the cartridge 140, the battery life of the cartridge 140 can be greatly increased. As shown, the doors 142A, 142B comprise a pair of shafts 82A, 82B of opposing sides of the doors 142A, 142B. Each shaft of the pair of shafts 82A, 82B is positioned within a shaft path 84A, 84B. In the open position, as shown in FIG. 26, the shafts 82A, 82B are located at a first end 86A, 86B of the shaft paths 84A, 84B. To close the doors 142A, 142B, the shafts 82A, 82B are moved within the shaft paths 84A, 84B toward a second end 88A, 88B of the shaft path 84A, 84B, as shown in FIG. 27. The doors 142A, 142B are connected to the shafts 82A, 82B and thus, as the shafts 82A, 82B move in the shaft paths 84A, 84B toward the second end 88A, 88B of the shaft paths 84A, 84B, the doors 142A, 142B are pushed out from within the shaft path 84A, 84B (as shown in FIG. 27).

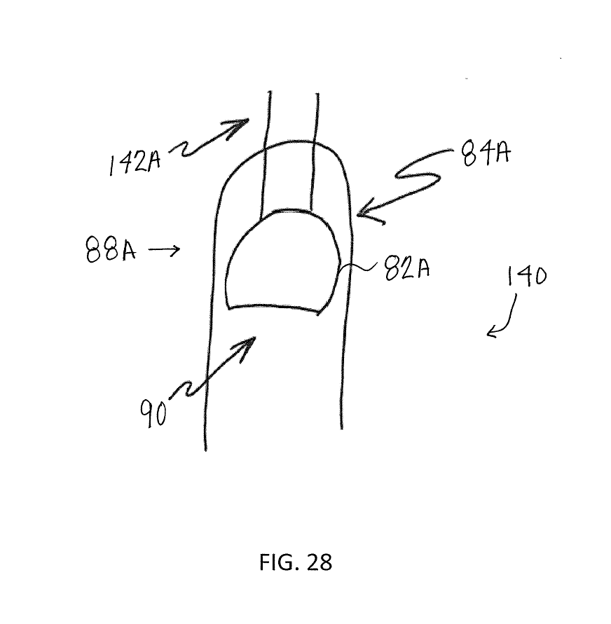

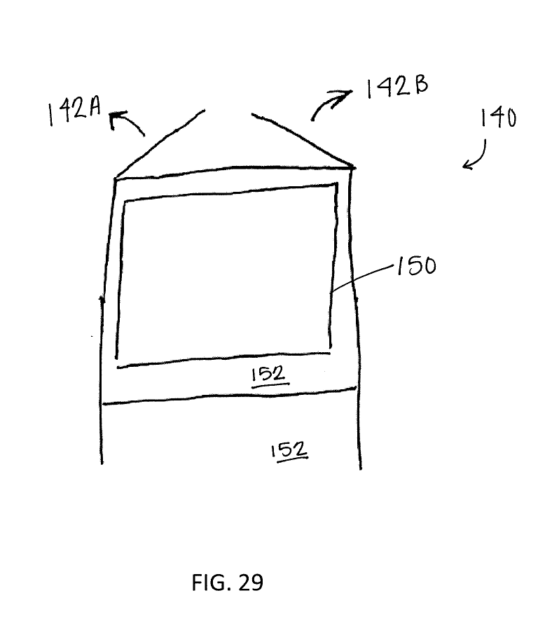

The shafts 82A, 82B each have a flat portion 90, as shown in FIG. 28. The flat portion 90 on the shafts 82A, 82B allows the shafts 82A, 82B to be rotated when the shafts 82A, 82B reach the second end 88A, 88B of the shaft paths 84A, 84B. Therefore, the doors 142A, 142B are fully extended from the shaft paths 84A, 84B (shown in FIG. 29) when the shafts 82A, 82B are at the second end 88A, 88B, and rotation of the shafts 82A, 82B (due to the flat portion 90), rotates and closes the doors 142A, 142B (not shown). It one embodiment, a rotation mechanism in the machine 14 interfaces with a cartridge 92 (described in detail below) and both pushes the shafts 82A, 82B within shaft paths 84A, 84B and rotates the shafts 82A, 82B at the second end 88A, 88B of the shaft paths 84A, 84B.

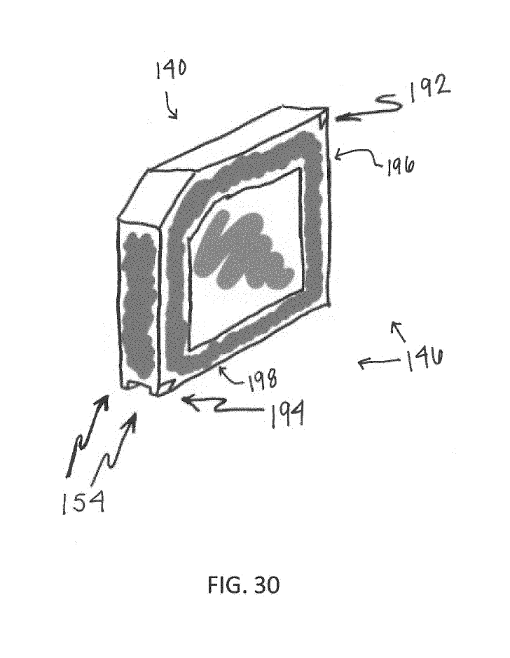

Referring now to FIGS. 30-33, there are shown various views schematic representations of a locking mechanism 146 of the cartridge 140, according to an embodiment. As shown in FIG. 30, the cartridge 140 the locking mechanism 146 comprises a first locking feature 192 and a second locking feature 194. The first locking feature 192 is located or otherwise positioned at a back side 196 of the cartridge 140 and the second locking feature 194 is located or otherwise positioned at a bottom side 198 of the cartridge 140 as shown in FIG. 30.

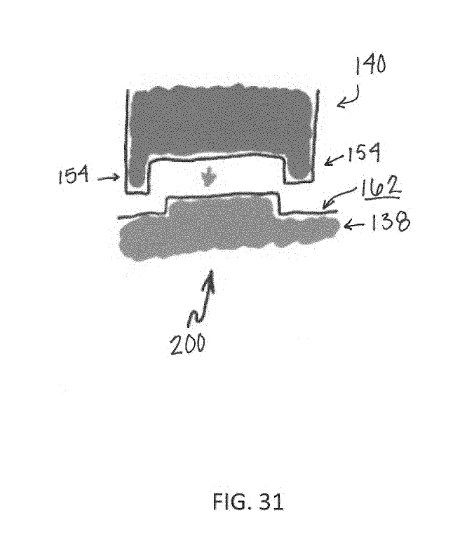

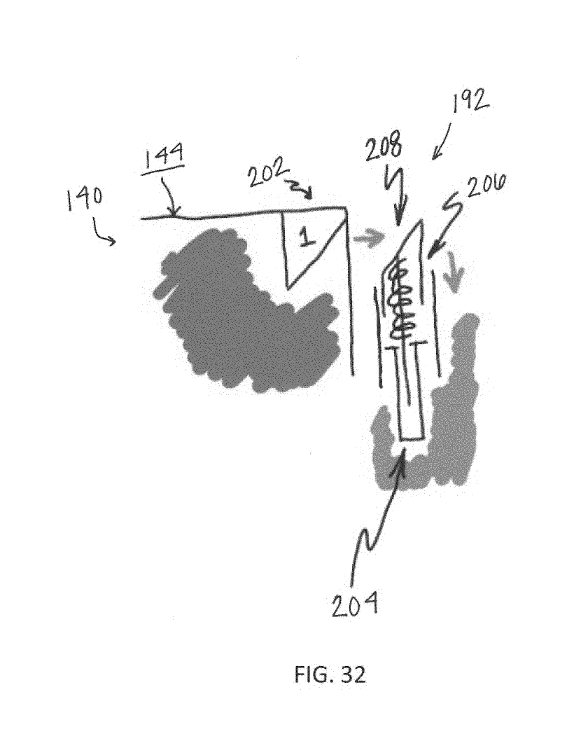

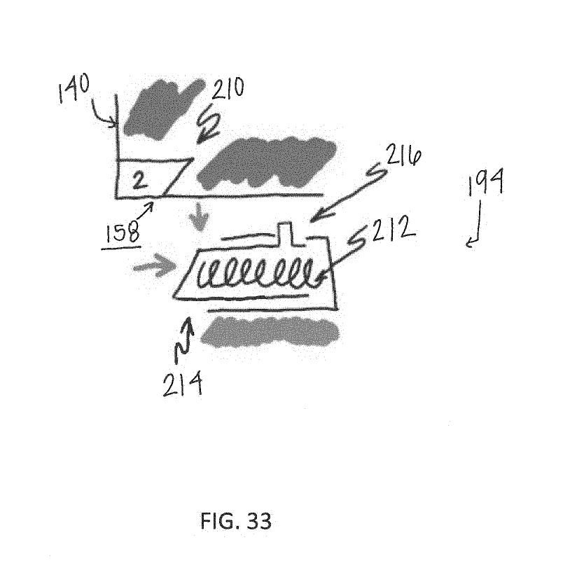

FIG. 31 shows a front view schematic representation of the cartridge 140 above an alignment feature 200 in the bottom interior surface 162 of the base 138 of the machine 14. As shown in FIG. 31, the alignment rails 154 of the cartridge 140 extend on either side alignment feature 200. Turning now to FIG. 32, the first locking feature 192 comprises a first mating surface 202 at the top surface 144 of the cartridge 140. The first locking feature 192 additionally comprises a first mechanical linear actuator 204 which extends within the cartridge 140 to the first mating surface 202. The first mechanical linear actuator 204 includes a spring 206, which extends up to a latch 208. Similarly, the second locking feature 194, shown in FIG. 33, includes a spring 212, which extends to a latch 214. The second locking feature 194 also comprises a second mating surface 210 which extends in the cartridge 140 to the bottom surface 158 thereof and abuts the latch 214. The second locking feature 194 also comprises a slider 216, which extends along the second locking feature 194 in the same direction as the pathway of the spring 212. In order to unlock the first and second locking features 192, 194, a user utilizes a connected application (e.g., web application), as described in detail below, to unlock the first locking feature 192, and then, the user manually advances the slider 216 to unlock the second locking feature 194. When the cartridges 140 are locked within the base 138 of the machine 14, the cartridges 140 can receive the pieces of the object 12 from the material compacting system 136.

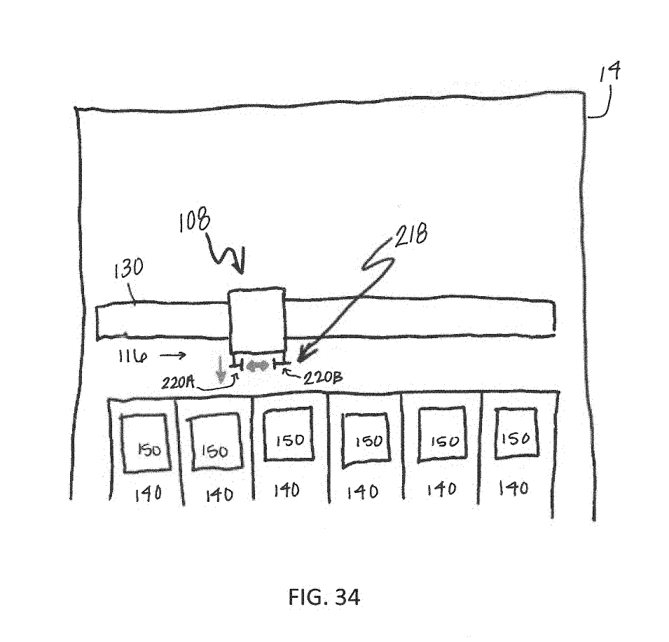

Referring now to FIG. 34, there is shown a front view schematic representation of the carriage 108 on a rail 130 of the rail system 110 above the one or more cartridges 140, according to an embodiment. In the depicted embodiment, one or more carriages 108 slide along a rail 130 within the machine 14. As shown in FIG. 34, the carriage 108 comprises a telescoping parallel grasper 218 at the bottom surface 116 of the carriage 108. In the depicted embodiment, the telescoping parallel grasper 218 includes grasping portions 220A, 220B that move in directions both toward and away from each other. However, the telescoping parallel grasper 218 itself moves in a direction perpendicular to the direction of the movement of the grasping portions 220A, 220B, which is toward and away from the cartridges 140, as shown in FIG. 34.

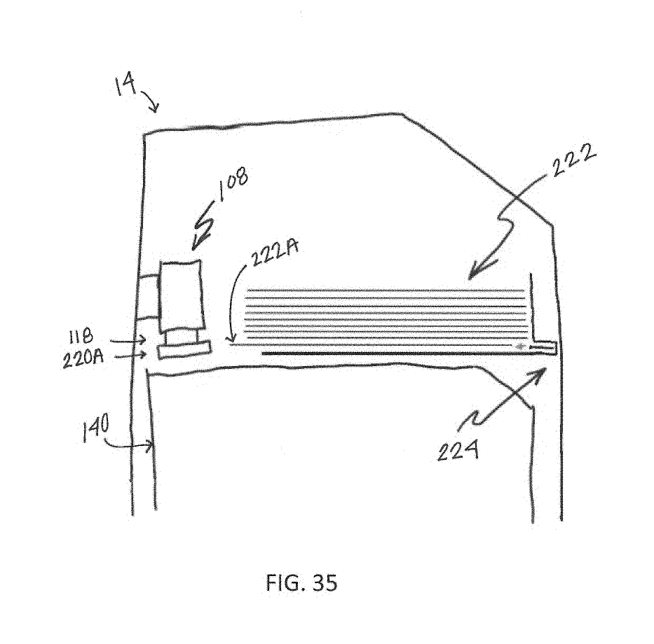

As shown in FIG. 35, the grasping portions 220A, 220B are used to grasp or grab a divider plate 222. One or more divider plates 222 are stored in the machine 14 at a location above the cartridges 140, as shown in FIG. 35. In the depicted embodiment, the divider plates 222 are in a stacked arrangement. A linear actuator 224 is aligned with the lowest divider plate 222A. In FIG. 35, the lowest divider plate 222A is the divider plate 222 closest to the cartridges 140. When actuated, the linear actuator 224 extends and pushes the lowest divider plate 222A in the path of the grasping portions 220A, 220B of the telescoping parallel grasper 218. The divider plates 222 are retrieved by the telescoping parallel grasper 218 until the stock of divider plates 222 is depleted. A user may replace the divider plates 222 upon routine service or when the stock is depleted.

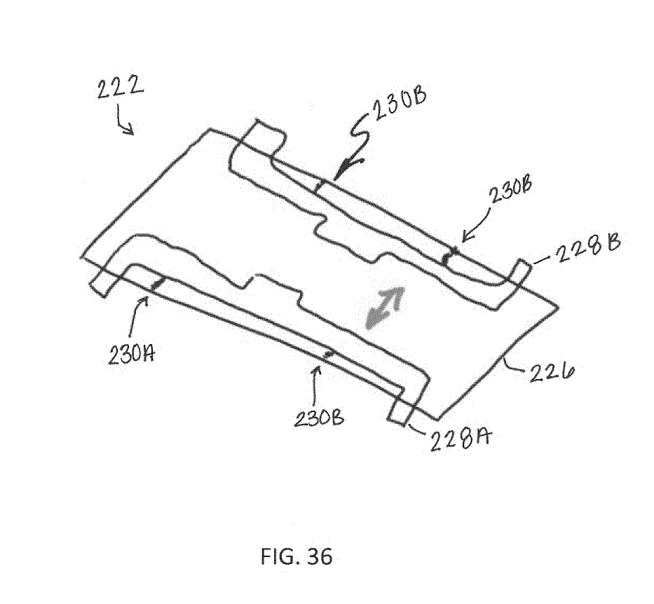

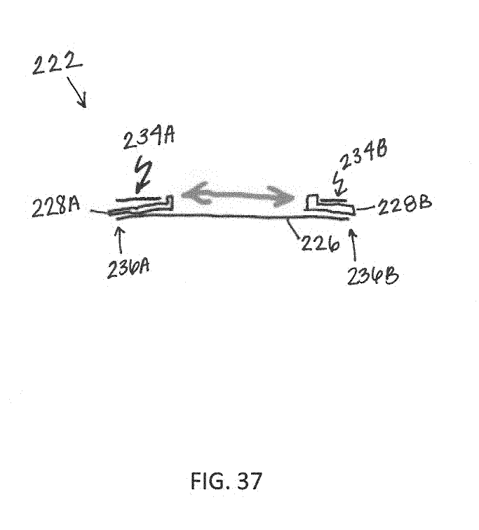

Turing now to FIG. 36, there is shown a top perspective view schematic representation of a divider plate 222, according to an embodiment. In the depicted embodiment, the divider plate 222 comprises a solid base layer 226 with one or more spring-loaded locking arms 228. As shown in FIG. 36, the divider plate 222 has a pair of locking arms 228 and each locking arm 228A, 228B is tensioned by a pair of small springs 230A, 230B. A side view of the divider plate 222 is shown in FIG. 37. As shown in FIG. 37, the divider plate 222 comprises a solid base layer 226 beneath the pair of locking arms 228A, 228B. In the depicted embodiment, there is a gap 323 between the pair of locking arms 228A, 228B. Further, there is a top layer 234A, 234B over the pair of locking arms 228A, 228B, between each locking arm 228A, 228B and the closest edge 236A, 236B of the base layer 226, as shown.

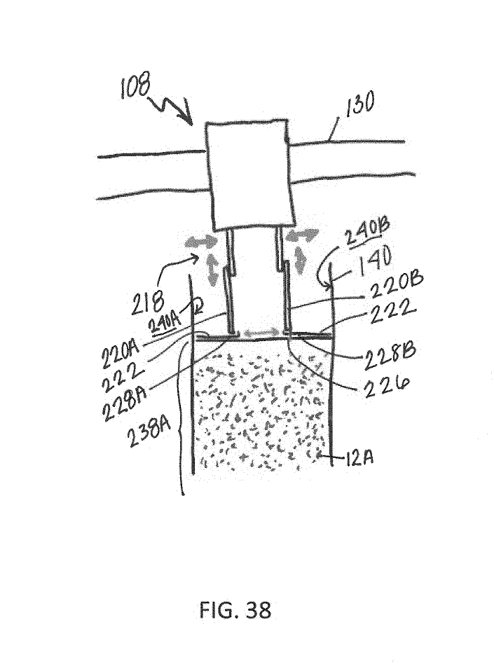

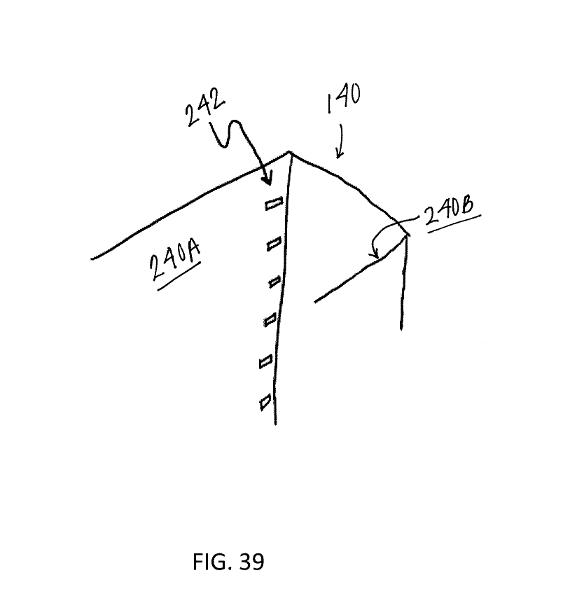

Referring now to FIG. 38, there is shown a side view schematic representation of the carriage 108 inserting a divider plate 222 into a cartridge 140, according to an embodiment. After the carriage 108 grabs a divider plate 222 in the grasping portions 220A, 220B of the telescoping parallel grasper 218, the carriage 108 is then moved along the rail 130 to a location above or adjacent a cartridge 140. The telescoping parallel grasper 218 extends from the carriage 108, pushing the divider plate 222 into the cartridge 140, as shown in FIG. 38. The grasping portions 220A, 220B first release the divider plate 222 in the cartridge 140 on top of a first volume of pieces of a first object 12A in a first storage area 238A of the cartridge 140. Then, the grasping portions 220A, 220B are used to pushing the locking arms 228A, 228B in opposing directions, as shown in FIG. 38. The locking arms 228A, 228B are pushing in opposing directions toward opposing interior surfaces 240A, 240B of the cartridge 140 until the locking arms 228A, 228B connect to notches 242 which are positioned along the opposing interior surfaces 240A as shown in FIG. 39. With the locking arms 228A, 228B secured within the notches 242, the divider plate 222 is secured above the first volume of pieces of the first object 12A. Further, the solid base layer 226 of the divider plate 222 creates a second storage area 238B within the cartridge 140 for a second volume of pieces of a second object 12B. Thus, the divider plate 222 separates the first and second storage areas 238A, 238B within the cartridge 140 and consequently separates the first and second volumes of pieces of objects 12A,12B.

Although not shown, a small laser range finder is located on the carriage 108 to determine which notches 242 to lock the divider plate 222 into. In other words, the small laser range finder detects the height of the first volume of pieces of the first object 12A. Although the machine 14 already indirectly detects the height of the first volume of pieces of the first object 12A via the weight and amount of the first object 12A, the small laser range finder provides a more direct method for measuring the of the first volume of pieces of the first object 12A in the cartridge 140. There are additional feedback mechanisms between the telescoping parallel grasper 218 and the notches 242 shown in FIG. 39. Although not shown, such feedback mechanisms include small magnets above each notch 242 and a Hall Effect, or similar magnetic sensor, in the telescoping portion of the telescoping parallel grasper 218. Indexing also occurs so that the telescoping parallel grasper 218 knows how far it has traveled (in addition to the encoder within the motor of the telescoping portion of the telescoping parallel grasper 218). Thus, there is an input encoder on the motor (not shown) of the telescoping parallel grasper 218 and an output encoder built into the wall (e.g., within at least one of the opposing interior surfaces 240A, 240B) of the cartridge 140 that is read by a magnetic sensor (not shown) in the telescoping parallel grasper 218.

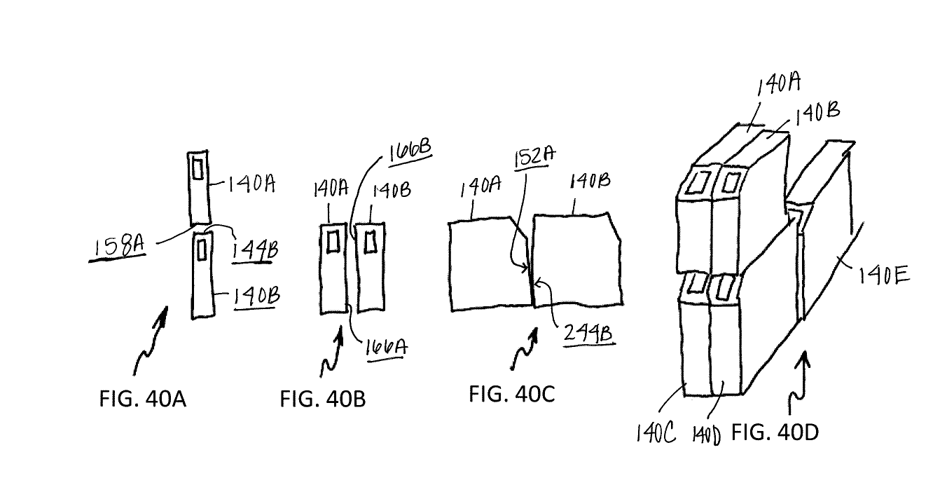

Turning now to FIGS. 40A-44, there are shown various views schematic representation of arrangements of one or more cartridges 140. In FIG. 40A, there is shown a bottom surface 158A of a first cartridge 140A stacked on a top surface 144B of a second cartridge 140B. In FIG. 40B, a first side surface 166A of the first cartridge 140A is stacked against a second side surface 166B of a second cartridge 140B. In FIG. 40C, a front surface 152A of the first cartridge 140A is stacked against a back surface 244B of the second cartridge 140B. Finally, in FIG. 40D, there is a multi-stack configuration of cartridges 140A, 140B, 140C, 140D, 140E, wherein the cartridges are stacked according to any combination of the configurations shown in FIGS. 40A-40C.

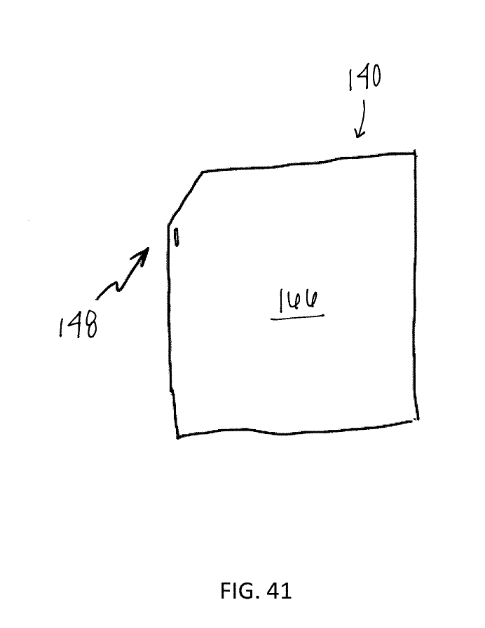

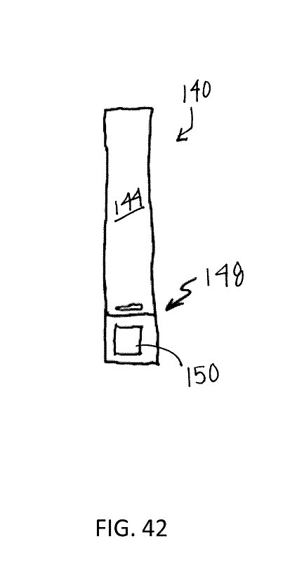

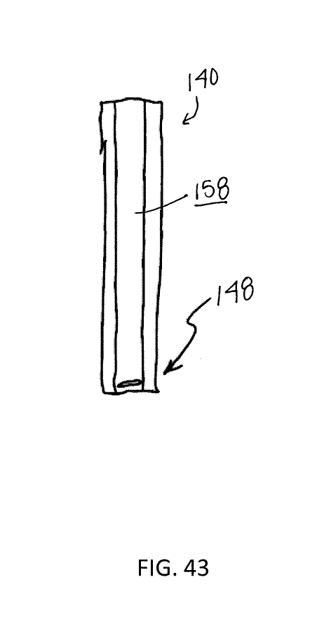

The configurations of cartridges 140 shown in FIGS. 40A-40D are possible because of the electrical connectors 148 which are disposed on each side (and surface) of each cartridge 140, as shown in FIGS. 41-43. For example, in FIG. 41, the electrical connector 148 (e.g., electrical pad or pogo pins) is on a side surface 166 of the cartridge 140. In FIG. 42, the electrical connector 148 is on the top surface 144 of the cartridge 140. In FIG. 43, the electrical connector 148 is on the bottom surface 158 of the cartridge 140. It is important to note that where the first cartridge 140A comprises an electrical pad, the second cartridge 140B comprises electrical pogo pins to facilitate the connection between the first and second cartridges 140A, 140B and to achieve the stacked configuration. Thus, in any stacked configuration of cartridges 140, data regarding all the stacked cartridges 140 can be transmitted and known. In one embodiment, scanning one of the cartridges 140 in the stack provide data regarding the contents of each one of the cartridges 140 in the stack.

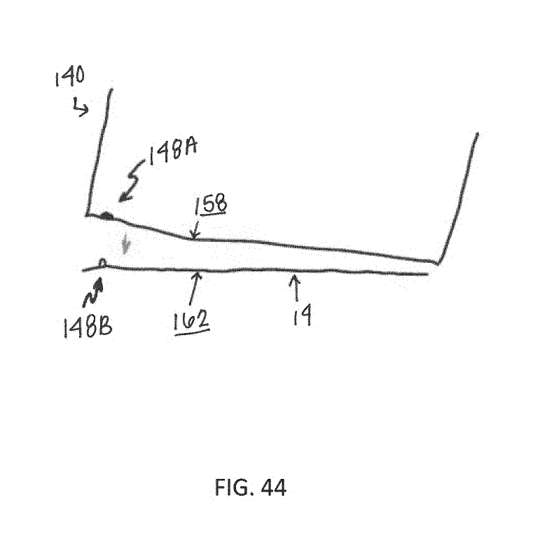

Referring now to FIG. 44, there is shown a close-up side view of the cartridge 140 at the bottom surface 158 of the machine 14, according to the embodiment. As shown, the bottom surface 158 of a cartridge 140 comprises an electrical pad 148A and the bottom interior surface 162 of the machine 14 comprises electrical pogo pins 148B. One electrical pin 148B is shown; however, more than one pin 148B may be used. Each cartridge 140 is charged when the electrical pad 148A of the cartridge 140 is connected to the electrical pogo pin(s) 148B at the bottom interior surface 162 of the machine 14. Power is transferred from the bottom interior surface 162 of the machine 14 to the cartridge 140. When the cartridge 140 is removed from the machine 14, the battery (not shown) powers the screen 150 of the cartridge 140. In addition, the battery (not shown) also provides power to the electrical connectors 148 to allow the cartridges 140 to communicate and transfer data between or among the cartridges 140. Data stored in the cartridge 140 includes metrics such as: how full the cartridge 140 is (e.g., depth (%), volume, weight), the type of (pieces) object 12 in the cartridge 140, the weight of the object 12 in the cartridge 140, the specific machine 14 that the cartridge 140 was last connected to, and the time associated with each of the preceding metrics.

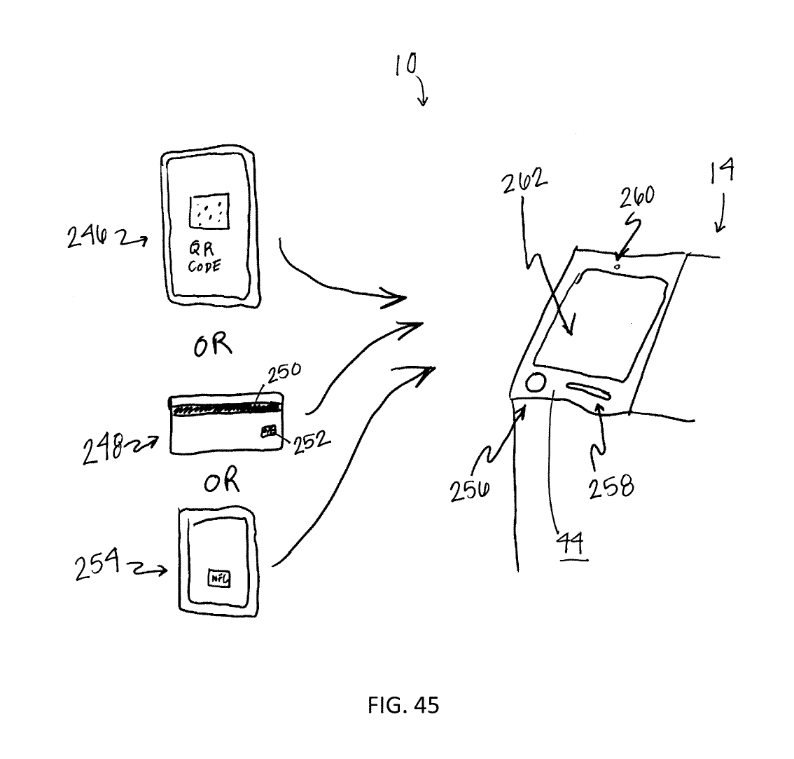

Turning now to FIGS. 45-59, there are shown various views schematic representations of the data flow within and between the machine 14 and the components of the machine 14. As shown in FIG. 45, the system 10 includes a cell phone 246 or other portable electronic device with a QR code (or other identifier), a debit card 248 with a stripe 250 and/or chip 252, or a cell phone 254 or other portable electronic device with near-field communication (NFC). Data flows from the cell phones 246, 254 or the debit card 248 to the machine 14, as shown in FIG. 45. For example, the machine 14 comprises a NFC transmitter 256, a card reader 258, and/or a camera 260 to scan the QR code on the front surface 44 of the machine 14 to receive the data. FIG. 45 also shows a screen 262 on the front surface 44 of the machine 14.

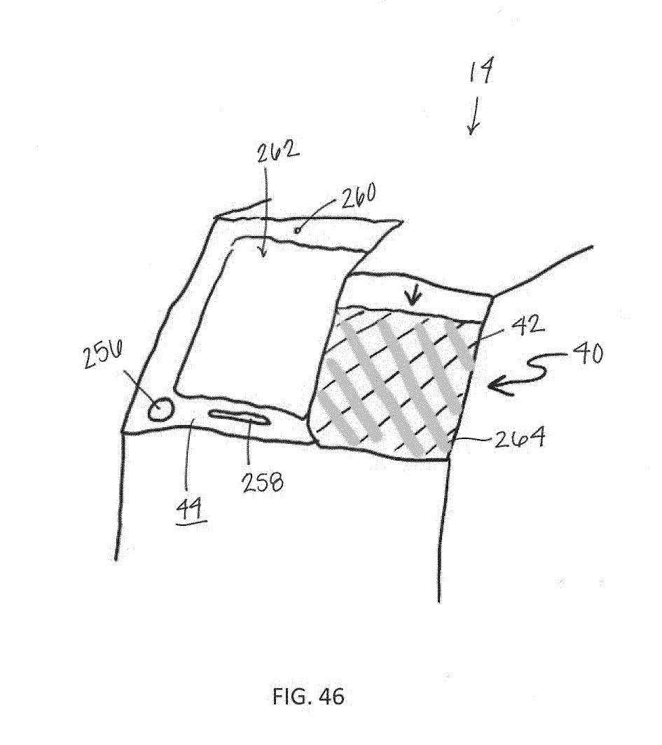

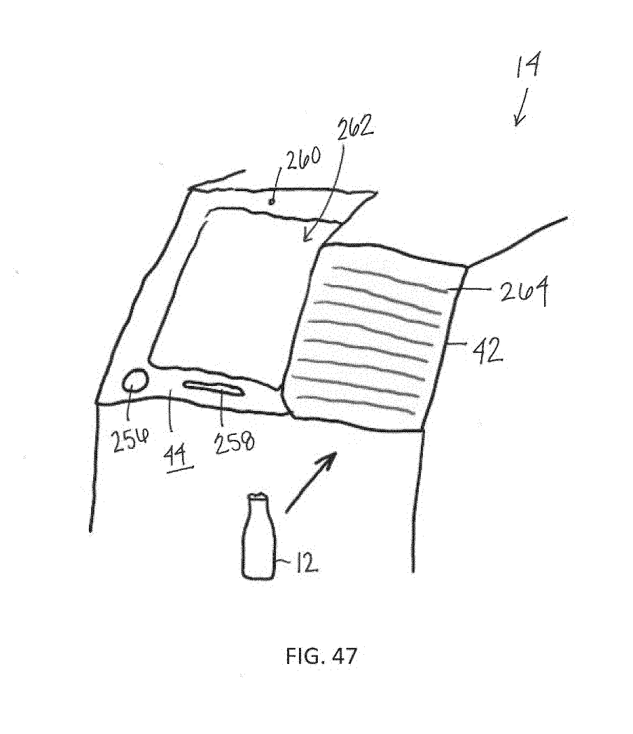

With the door in the closed position (in FIG. 46), the user inputs his/her account information into the machine 14 via the screen 262 (e.g., an interface on the screen 262). Upon receiving the user account information, the door 40 of the machine 14 moves to the open position, as shown in FIG. 47. In the open configuration, a light curtain 264 extends across the entrance 42 (i.e., perimeter around the doors 40) to the machine 14. When a user places an object 12 through entrance 42 and the safety light curtain 264, the safety light curtain 264 is broken and the machine 14 begins collecting data.

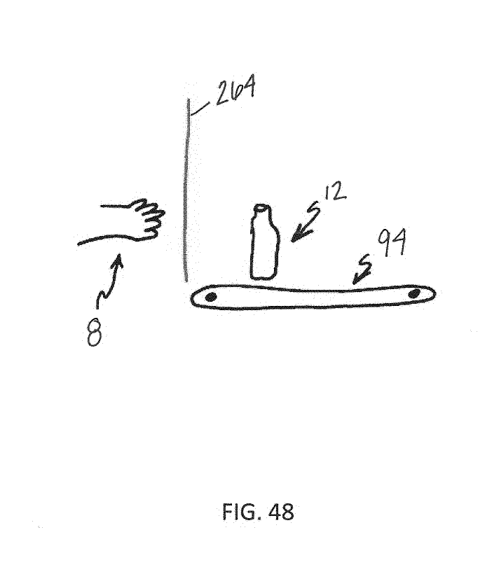

Referring briefly now to FIG. 48, there is shown a side view schematic representation of the safety light curtain 264, according to an embodiment. As shown in FIG. 48, the safety light curtains 264 extend across the entrance 42 of the machine 14. The safety light curtain 264 can detect a hand 8 or other object 12 extending through the safety light curtain 264.

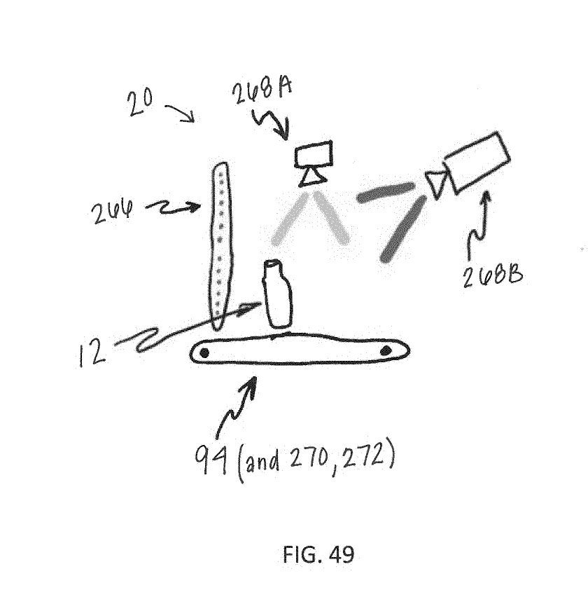

Referring now to FIG. 49, there is shown a side view schematic representation of internal components of the machine 14. As shown in FIG. 49, when an object 12 is deposited through the entrance 41 of the door 40 and into the machine 14, the object 12 is on a conveyor belt 94 within the machine 14. The object 12 is moved along the conveyor belt 94 until it is within range of a first sensor system 20 for determining the identity of the object 12. The first sensor system 20 includes a laser scanner 266 and cameras 268 in the machine 14. As shown in FIG. 49, the machine 14 collects data from the object 12 via the laser scanner 266 and cameras 268. In the depicted embodiment, a first camera 268A is a vision camera and a second camera 268B is a hyperspectral camera. It total, there are as at least five different assemblies in the first sensor system 20 acquiring data from the object 12 simultaneously. The sensing assemblies include a hyperspectral camera 268B, one or more machine vision cameras 268A, a scale 270, one or more laser scanners 266, and an inductance system 272. In the depicted embodiment, the conveyor belt 94 incorporates the scale 270 and inductance system 272. In one embodiment, the machine 14 may rotate the object to sense/detect the barcode 28. If a barcode 28 is not visible, the machine 14 will use other methods to determine composition, such as use of the cameras 268. The machine 14 will also have a database of materials to determine what material to which that specific barcode 28 applies. In addition to being linked to the code scanning system 26, system 10 may also use other methods of determining the material such as analyzing the spectral characteristics of the plastic if no barcode 28 is visible. The machine is configured to use multiple methods to increase confidence that the object 12 being recycled is a specific material.

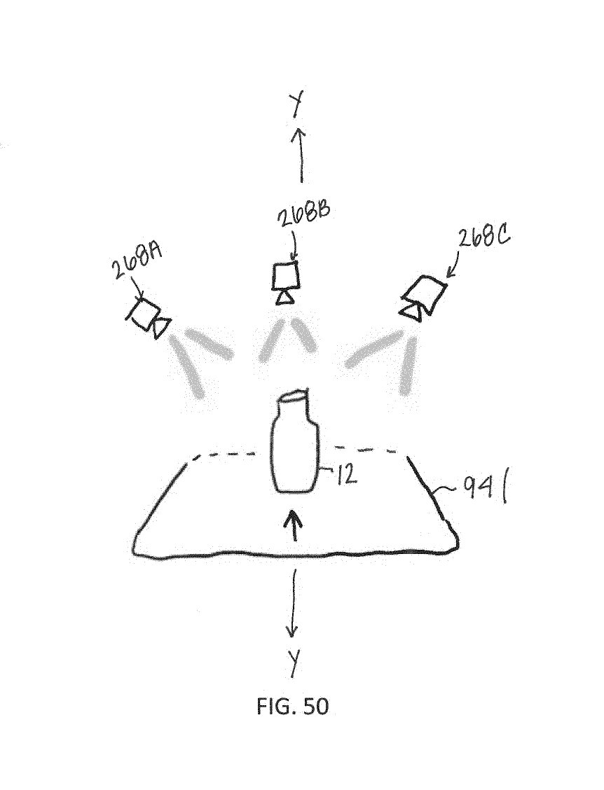

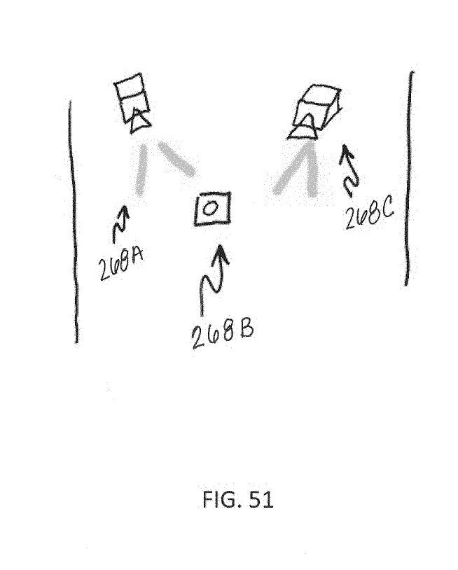

Turning now to FIG. 50, there is shown a front view schematic representation of the machine vision cameras 268A, 268B, 268C in the machine 14. In the depicted embodiment, the object 12 is located or positioned on the conveyor belt 94 with three machine vision cameras 268A, 268B, 268C positioned (each) at an angle relative to a vertical y-y axis through the center of the conveyor belt 94. FIG. 51 shows a top view of the three machine vision cameras 268A, 268B, 268C. The three machine vision cameras 268A, 268B, 268C are arranged in a triangular configuration. The second vision camera 268B is pointed directly downward, a first vision camera 268A is angled downward in a direction toward the vertical y-y axis, and a third vision camera 268C is spaced from the first vision camera 268A and angled downward in a direction toward the vertical y-y axis, as shown in FIG. 50.

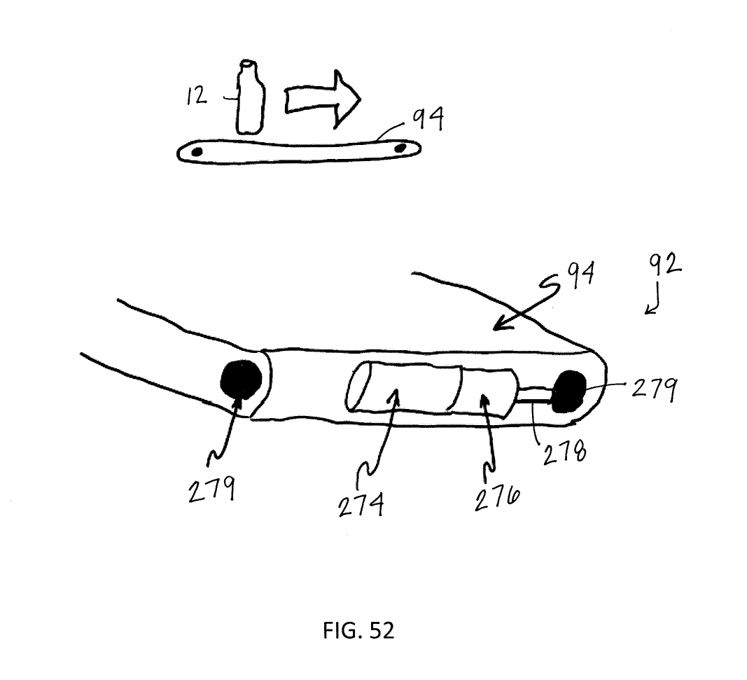

Referring now to FIG. 52, there is shown a perspective side view schematic representation of the conveyor belt assembly 92, according to an embodiment. In FIG. 52, the conveyor belt assembly 92 and conveyor belt 94 are a standard industrial conveyor belt assembly and conveyor belt. As such, not all parts are shown. In FIG. 52, the conveyor belt assembly 92 has motor 274, which is connected to one or more gears (not shown) in a gear box 276. The motor 274 rotates the gears (not shown) in the gear box 276, which rotate a shaft 278, which is connected to a pair of drive wheels 279, which rotate the conveyor belt 94. Rotation of the shaft 278 rotates the conveyor belt 94, moving the object 12 within the machine 14.

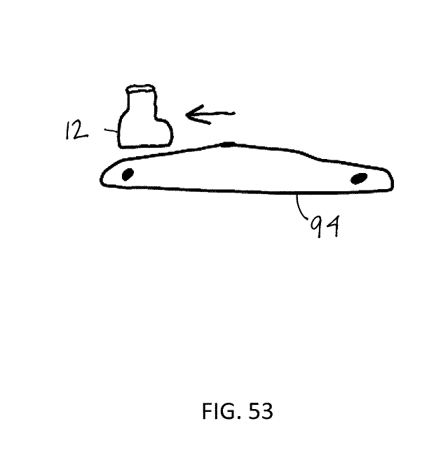

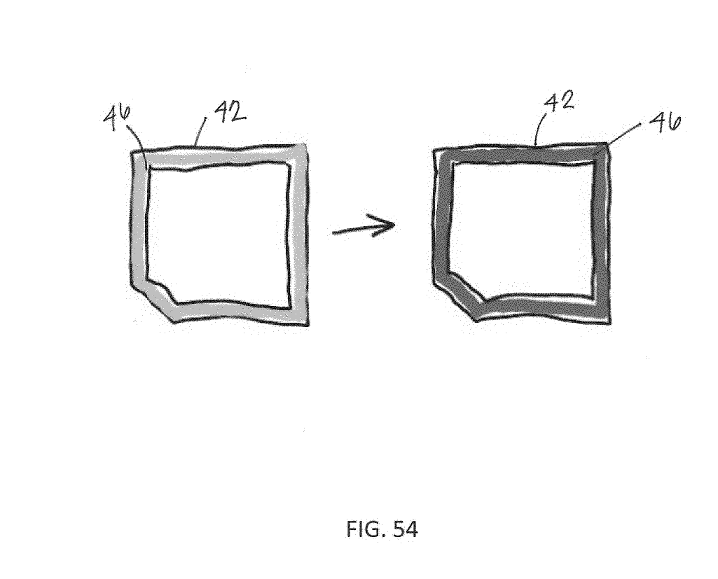

If, using the first sensor system 20 as described above, the machine 14 cannot detect the identity of a deposited object 12, the machine 14 with reverse the movement of the conveyor belt 94, as shown in FIG. 53, to place the object 12 in the range of the first sensor system 20 in order for the first sensor system 20 to have a better view of the object 12. If the machine 14 still cannot identify the object 12, the object 12 cannot be recycled. The conveyor belt 94 will continue to move the object 12 in the direction toward the door 40 of the machine 14. The machine 14 will transmit an alert or other notification indicating that the object 12 cannot be recycled. In one embodiment, the alert is a notification on the screen 262 of the machine 14. In another embodiment, the alert is a sound emitted by a speaker (not shown) of the machine 14. In yet another embodiment, the alert is a color change of the light, from the light source 46, emitted from the entrance 42 of the machine 14, as shown in FIG. 54. In some embodiments, the alert is a notification transmitted to a user's mobile device (e.g., smart phone or cell phone 246, 254).

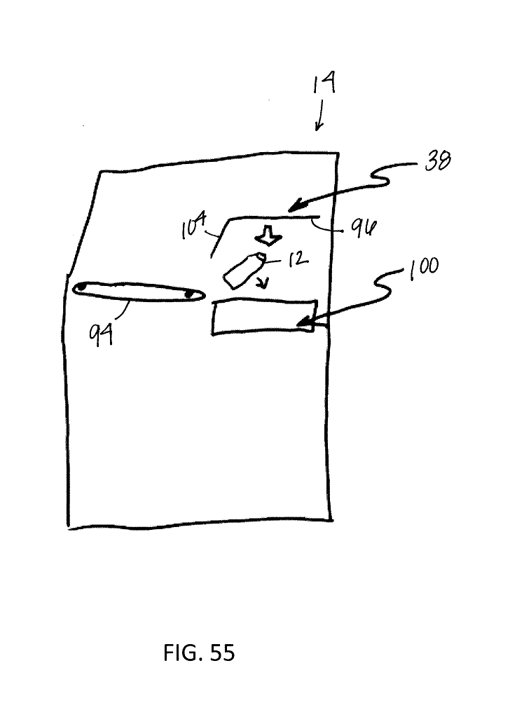

If the machine 14 is able to determine the identity of the object 12, the conveyor belt 94 continues to move the object 12 toward the material compacting system 38. The conveyor belt 94 moves the object 12 into the material compacting system 38 in the open position. Then, the plate 96 and shield cover 104 are moved downward on top of the object 12, pushing the object 12 into the shredder 100, as shown in FIG. 55. When the material compacting system 38 is in the closed position, the shield cover 104 prevents shredded pieces of the object 12 from flying out from the shredder 100 (and out of the machine 14). The shield cover 104 also helps to push the object 12 into the shredder 100. In one embodiment, while the machine 14 is shredding the object 12 the entrance 42 of the machine 14 has a certain color of light emitted from the light source 46. The screen 262 of the machine 14 may also display a notification (e.g., in text) that the object 12 is being processed.

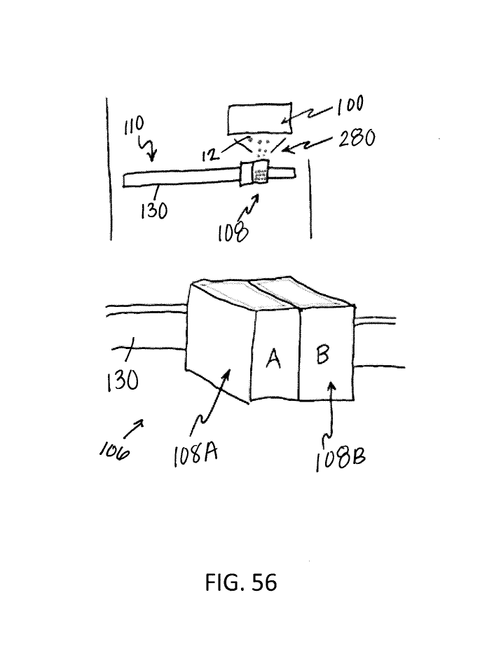

Referring now to FIG. 56, there is shown a front perspective view of the internal components of the machine 14. In the depicted embodiment, the shredder 100 is located or otherwise positioned in the machine 14 above rail system 110 with one or more carriages 108. As shown in FIG. 56 and as described above, the carriages 108 slide along the rail 130 until at least one of the carriages 108 is positioned beneath and aligned with the shredder 100. In one embodiment, a funnel 280 extends between the shredder 100 and the carriage 108, as shown in FIG. 56. The funnel 280 facilitates transfer of the shredded pieces of the object 12 into the carriage 108. In one embodiment, once the object 12 is shredded (i.e., the shield cover 104 is at a position above the object 12), the entrance 42 machine changes the color of light (e.g., to green) emitted from the light source 46. When a first carriage 108A is full, a second carriage 108B can be filled, as shown in FIG. 56.

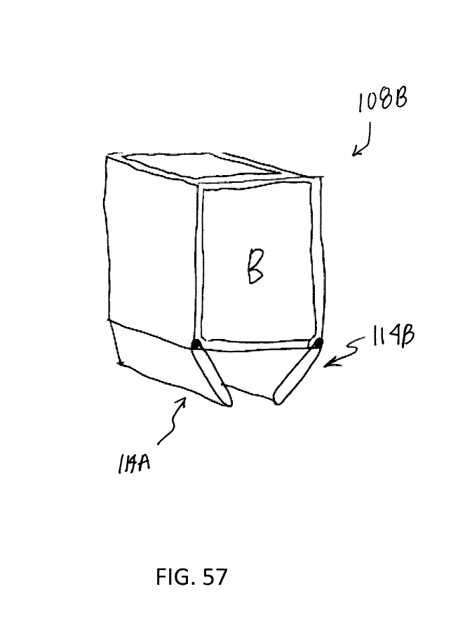

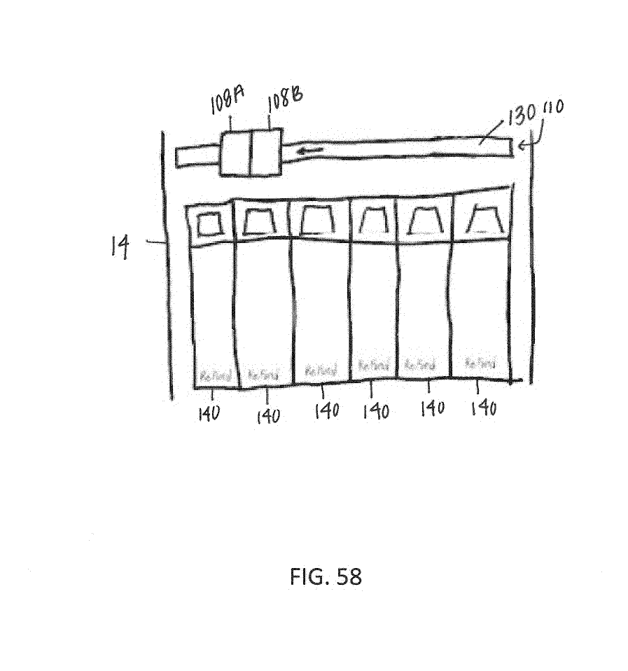

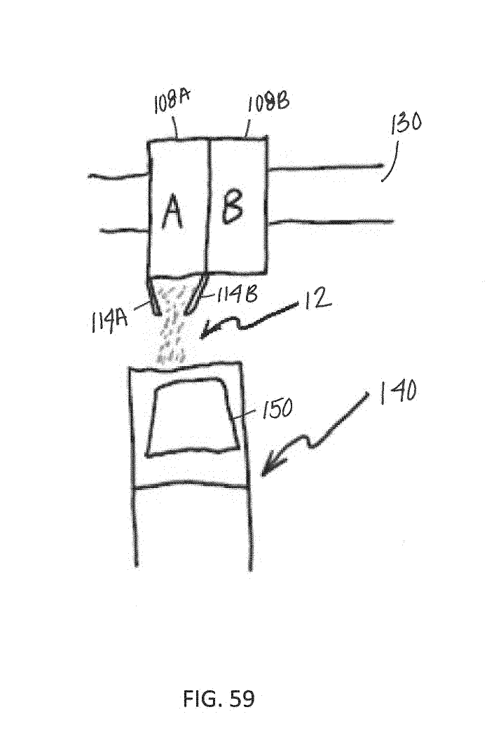

As described above (and shown in FIG. 17), the doors 114A, 114B of the carriage 108B can move from the closed position to the open position, shown in FIG. 57, in order to deposit the shredded pieces of object 12 into a select cartridge 140. After the carriages 108 are filled, the carriages 108 are moved along the rail 130 to a position above a selected cartridge 140, as shown in FIG. 58. Once the carriage 108 is positioned above the selected cartridge 140, the doors 114A, 114B of the carriage 108 rotate from the closed position to the open position and deposit the shredded pieces of the object 12 into the cartridge 140, as shown in FIG. 59.

In one example, an object 12, such as a plastic bottle, is deposited into the machine 14 through the entrance 42. Once the plastic bottle 12 is in the machine 14, the laser scanners 266 (e.g., bar code readers) and machine vision cameras 268A quickly identify the exact UPC code for the plastic bottle 12. The laser scanner 266 (e.g., bar code reader) does this by reading the lines of the bar code on the plastic bottle 12. The machine 14 references a database stored on the hard drive within the machine 14. The machine vision cameras 268A compares photo taken from its different views to photos it has been trained from to identify the color, size, and shape of the plastic bottle 12 and thus, the plastic bottle 12 is initially identified in two ways.

The hyperspectral camera 268B detects high-density polyethylene (HDPE) in both the plastic bottle 12 its cap (not shown), which also gets fed into the sensor fusion algorithms and correctly matches data stored about this plastic bottle 12. The scale 270 measures the weight of the plastic bottle 12 (e.g., 102 grams), which is cross-referenced with the onboard database. The plastic bottle is determined to be about 1.5% higher than a completely empty container with the cap. The threshold for this specific item is 1.74%, thus the item passes.

Accordingly, the laser scanners 266, machine vision cameras 268A, hyperspectral camera 268B, and scale 270 retrieve information (i.e., data) regarding the plastic bottle (i.e., object) 12 to create a digital record in a storage medium of the machine 14. Thus, for every transaction or deposit of an object 12, key pieces of information, including, but not limited to, the type of material of the object, the weight of the material, the value of the material, the sources or uses of the material (e.g., coke bottle, blueberry container), the location of the transaction (i.e., deposit), the times of the transaction (i.e, deposit) are recorded. It is important to note that even though each object 12 is a single entity, the specific object 12 may be recorded as components comprising the object 12. Further, data from two or more transactions (i.e., deposits) can be grouped together for each individual interacting with the machine 14 and stored in a storage medium of the machine 14. The data for the group of transactions for a particular individual is then hashed (e.g., via a processor of the machine 14) for encryption. Although the machine 14 uses sensors (e.g., laser scanners 266, machine vision cameras 268A, hyperspectral camera 268B, scale 270), the object 12 is physically transformed through its destruction at the same time it is digitized. Thus, the physical transformation enables the digitization. Data regarding each object 12 can be retrieved and stored according to any type (e.g., booleans, numbers, strings).

Continuing the example, due to the item passing its set of specific guidelines as stated above, the conveyor belt 94 sends the item directly to the shredder 100 without the need to be rescanned. The plate 96 of the material compacting system 38 moves from an open position to a closed position over the plastic bottle 12, pushing the plastic bottle 12 into the shredder 100. Once the shield cover 104 abuts the conveyor belt 94 or is aligned with or adjacent to the conveyor belt 94, the shredder 100 begins to shred the plastic bottle 12. Contact of the shredder 100 with the plastic bottle 12 is detected by the machine 14. The shredded pieces of the plastic bottle 12 are also detected exiting the shredder 100 as the shredded pieces of the plastic bottle 12 are funneled into a carriage 108 beneath the shredder 100. At the same time, as the shredder 100 no longer senses the plastic bottle 12, the plate 96 and the shield cover 104 is retracted to the open position.

The carriage 108 moves along a rail 130 to a position over a designated HDPE cartridge 140. The shredded pieces of the plastic bottle are funneled into the HDPE cartridge 104. As the funneling occurs, the weight of the HDPE cartridge 140 (and other recorded data) is transmitted to the servers (not shown) of the system 10. The servers can be located at external locations (not in the machine 14). The servers might be in remote office location or hosted by a cloud service. The machines 14 can communicate via wireless cellular connection in most cases (e.g., LTE, 4G, 3G) or a wired connection to the servers, if needed.

As mentioned above, the data retrieved from the plastic bottle 12 is transmitted to the server. Via the server, cryptocurrency transactions can be recorded (i.e., executed). Here, smart contracts are created to enable the safe transaction of goods and services between multiple parties. Ownership allocation is also conducted. In other words, the digital record of the object 12 is linked to a specific account with public and private keys. In one embodiment, wherein the object 12 is regenerated or transformed into its raw material form, the transaction is recorded to the blockchain after material comprising the object 12 is transferred to particular parties in the ecosystem that create raw materials from sorted recyclables. Although the specific object 12 is no longer owned, a new raw amount of material (originally comprising the object 12) is owned. The original object 12 is only recorded in the previous blocks of the blockchain and can no longer be transacted. In other words, the use of the object 12 for transactions is exhausted when the object 12 is transformed into its raw material form.

In some embodiments, transactions may also occur between entities via side-chains, oracles and cross-chains. These interactions facilitate the connection between the general recycle token 16 that acts as a value carrier and a specific material token 16 that record specific information within a private database. It is important to note that the process is adaptive to a case where the digitization occurs when an object 12 is initially manufactured.

Continuing the example, approximately 0.01 tokens 16 of HDPE are minted on the internal blockchain of the system 10. The value of the HDPE is checked on database of the servers of the system 10 (e.g., $0.21/kg). After factoring in the specific location of the machine 14 (e.g., machines closer to the recycling centers pay slightly more), the user is credited with recycle tokens 10 (e.g., 0.608 recycle tokens) at the current conversion rate (e.g., $0.013). A database (connected to or stored via the servers) creates a “spot price” for different types of recyclable materials (i.e., objects 12). For example, in one embodiment, the conversion rate is the rate at which processing centers (e.g., places that pelletize plastics and smelt aluminum) are willing to pay for the pieces of the object 12.

In another embodiment, many other sources will be queried for data regarding the conversion rate. For example, the conversion rate may fluctuate with time and be updated instantaneously as quotes are received from processing centers. Further, after use of the machine 14, the servers will gather data (information) with a sufficiently large percentage of the supply of recyclable materials (i.e., objects 12) that the conversion rate will not simply reflect the demand of processing centers but the supply and demand of the entire supply chain. However, it is also important to note that a dynamic conversion rate will also apply to every transaction based on many other factors, such as the profit or revenue to the company.

Once the plastic bottle 12 has been processed, the payment transmitted to the user (or user account) is based on the weight of the plastic bottle 12. As the value of plastic bottle 12 is constantly changing, the instantaneous values are stored on the servers of the system 10, as described above. Once the weight of the plastic bottle 12 is determined, the value of the recyclable material that comprises the plastic bottle 12 is calculated by contacting the server using mobile data transfer. A digital wallet associated with the user that recycled the plastic bottle 12 is then filled with the corresponding amount of recycle token 16. The digital wallet also exists on the servers.

The user can access the digital wallet via the web application (e.g., on iOS or Android for example). Thus, the web application and the wallet communicate via encoded cellular or Wi-Fi connection on the mobile device, which communicate to the servers. The user's bank account can also be connected to the web application using standard methods. In another embodiment, a third party bank that conducts cryptocurrency to fiat conversions, such as Nobel Bank International, can be an intermediary in the process if the system 10 does not hold fiat in a reserve. Users will additionally have access to a desktop version of his or her digital wallet that can be accessed on a website (i.e., web platform or web application). From this digital wallet, they will not be able to interact with a machine 14, but they will be able to transfer money to their bank account or transfer cryptocurrency to another digital wallet. Additionally, the system 10 can be scaled for municipalities, processors, or industrial users. The scaled system 10 will enable entities to see a large amount of information about machines 14 that they have leased, the type, size, location, time, of recyclables that come into and out of their domain.

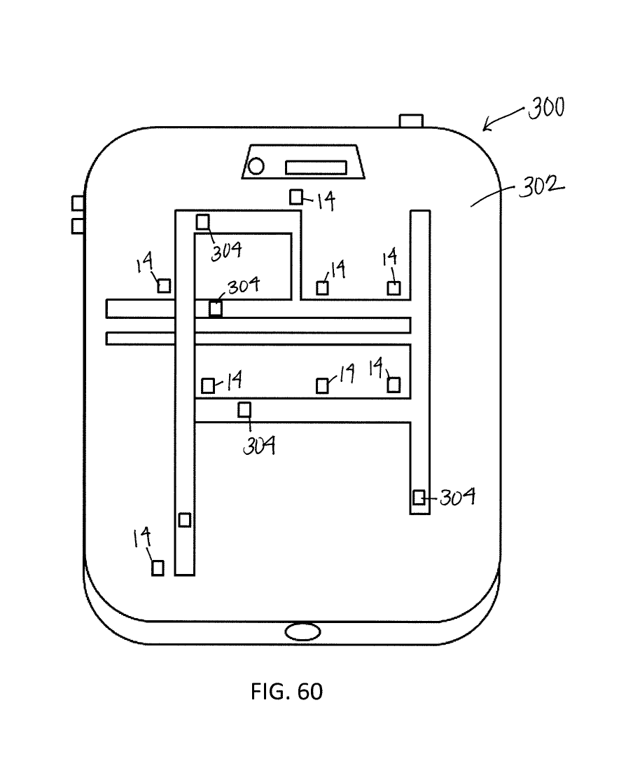

As described above and now referring to FIG. 60, an application software program stored on a smart phone or equivalent computing device 300 has a graphical user interface 302 that alerts to the full condition of a cartridge 140 and its location. An individual authorized to use the smart phone application (shown on the GUI as icons 304) may then perform maintenance on machine 14 and empty cartridge 140. The smart phone application provides a map of the machine's location and the location of other authorized users 304 of the application so that the authorized user 304 closest to a machine 14 can perform the maintenance, unless a different authorized user 304 sends an alert that he/she will perform the maintenance. Once the maintenance has been performed, the smart phone application reveals the same based on the sensor data.

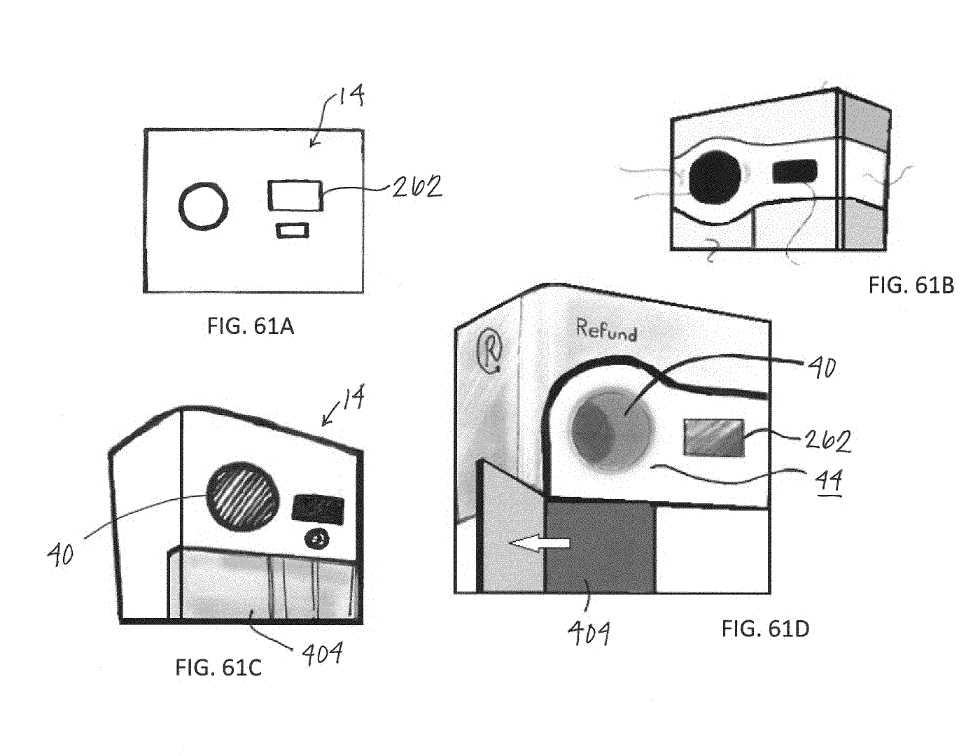

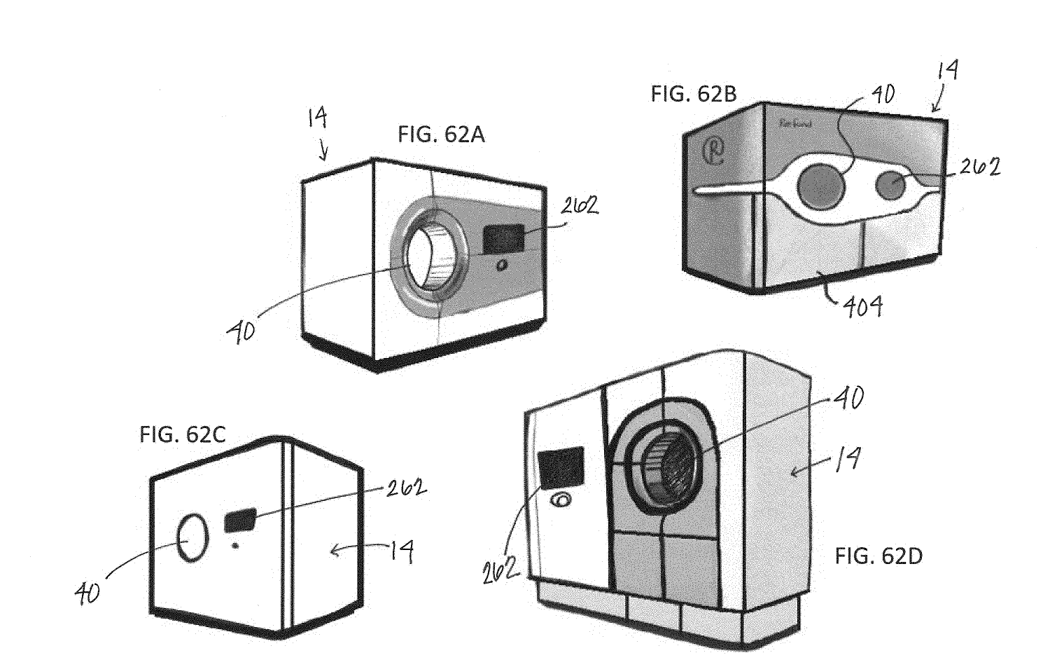

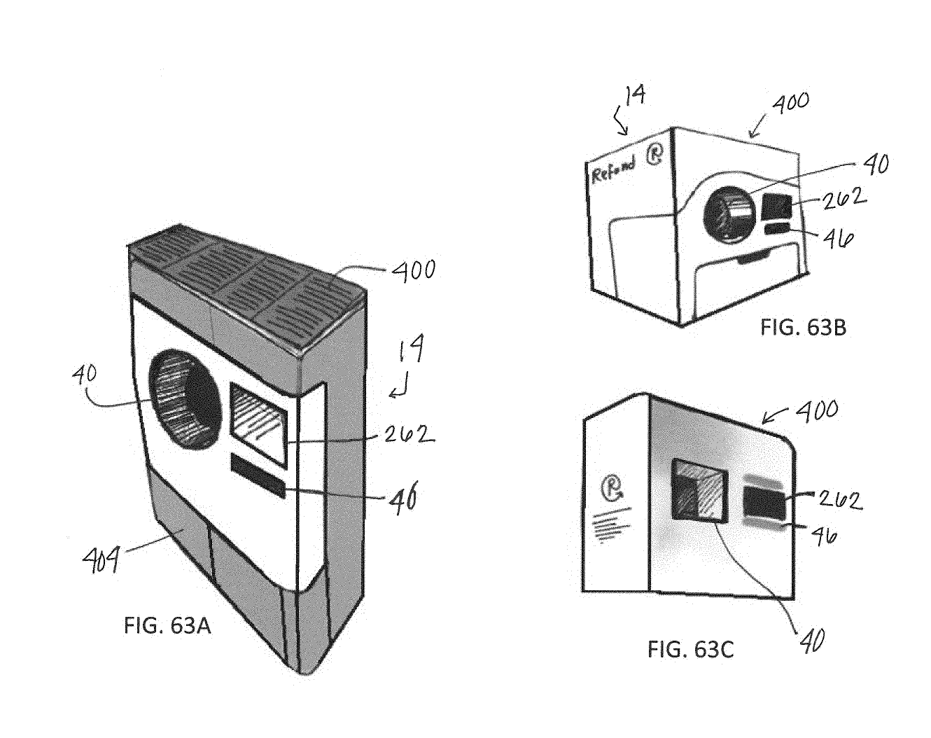

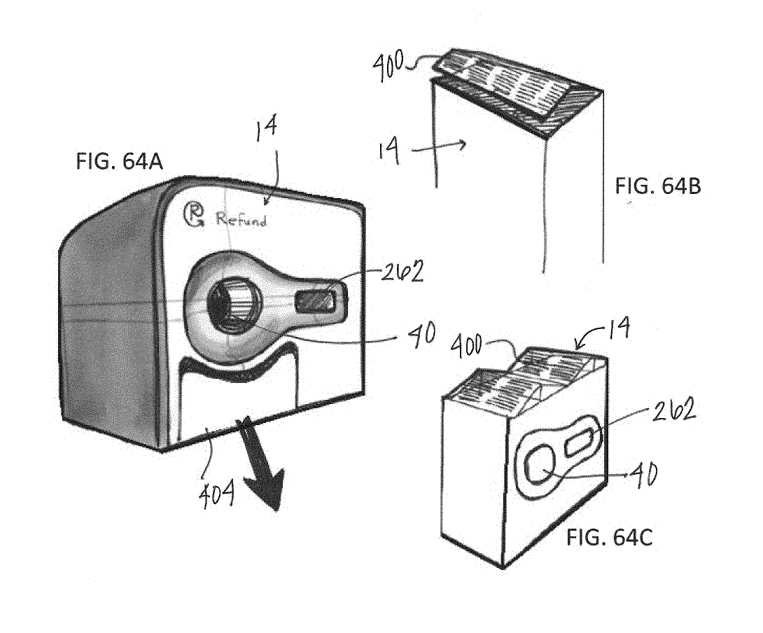

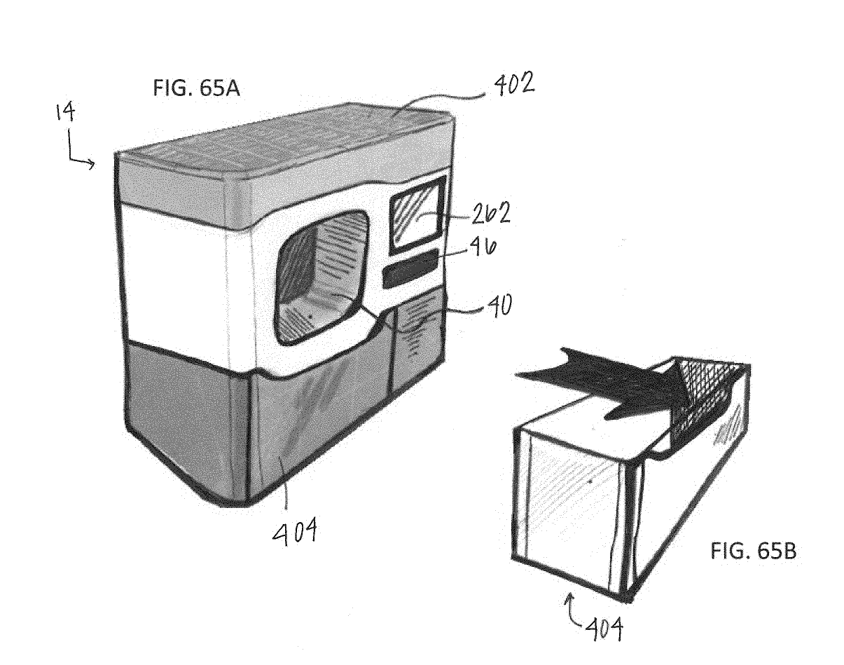

FIGS. 61A-62D provide further illustrative examples of machine 14, while FIGS. 63A-65B provide further illustrative examples of the machine 14, which is powered by solar cells 400 or photovoltaic cells 402 (machine 14 can be powered by DC batteries, AC power source, solar, wind, other known energy supply). In the embodiments shown in FIGS. 63A-65B, the solar cells 400 or photovoltaic cells 402 are attached or otherwise connected to a top surface 404 of the machine 14. However, other alternative configurations or positions for the solar cells 400 (or photovoltaic cells 402) are contemplated. Further, the illustrative examples of the machine 14 in FIGS. 61A-65B show a collection door 404, which is movable between a closed position and an open position. When the collection door 404 is in the open position, the user may retrieve the cartridges 140 stored in the machine 14. Removal of the cartridges 140 is necessary to empty cartridges 140 which are full with pieces of objects 12 (i.e., recyclable material). Alternative configurations and positions for the collection door 404 on the machine 14 are contemplated.

In an additional embodiment, which can be integrated or otherwise implemented by any of the aforementioned embodiments, the machine 14 further includes a holding container (not shown). Multiple objects 12 can be deposited into the holding container simultaneously. For example, a user can empty an entire bag of recyclables into the holding container itself, or into a door or chute connected to the holding container. One or more of the multiple objects 12 are momentarily stored internally (within the machine 14) and are then processed by the machine 14. The operation of the machine 14 in processing the multiple objects 12 essentially follows the method described above. However, the objects 12 that are not recognized by the machine 14 are deconstructed and stored in a separate internal compartment (not shown) for disposal by a maintenance worker (human or robotic), instead of moved back toward the door 40 by the conveyor belt assembly 92.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto; embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A machine for processing recyclable materials deposited therein, comprising:
a. an input adapted to receive a plurality of recyclable material objects deposited therein;
b. a sensor system for sensing and distinguishing the type of recyclable material deposited therein;
c. a weighing member for weighing the recyclable material deposited therein; and
d. a crypto-currency dispensing system for dispensing crypto-currency in an amount corresponding to the type of recyclable material deposited therein and the weight of the recyclable material deposited therein.

2. The machine according to claim 1, wherein said machine further comprises a code scanning system, and the recyclable materials deposited therein further include a scannable code incorporated therein, wherein said scannable code encodes data representative of the recyclable material type and weight.

3. The machine according to claim 2, wherein said crypto-currency dispensing machine is linked to said code scanning system and is adapted to dispense crypto-currency based upon said encoded data.

4. The machine according to claim 1, wherein said crypto-currency is distributed in the form of tokens composed of the same material and having the same currency value as the type and weight of the recyclable material deposited therein.

5. The machine according to claim 1, wherein said crypto-currency is distributed electronically to an individual's electronic account.

6. The machine according to claim 1, further comprising a debit card reader and means for encoding a predetermined value of crypto-currency onto a debit card.

7. The machine according to claim 1, further comprising computer code stored on a non-transient storage medium for communicating redeemed crypto-currency values with an electronic ledger.

8. The machine according to claim 1, further comprising a second sensor for determining when the machine is full of recycled material.

9. The machine according to claim 1, further comprising a third sensor for determining when the machine is broken.

10. The machine according to claim 1, further comprising a material compacting system for reducing the volume of recycled material deposited therein.

11. A machine for processing recyclable materials deposited therein, comprising:
a. an input adapted to receive a recyclable material object deposited therein;
b. a conveyor belt assembly configured to transport the recyclable material object from the input to a sensor system and a material compacting system,
i. the sensor system for sensing and distinguishing the type of recyclable material deposited therein, and
ii. the material compacting system adapted to destruct the recyclable material object into two or more pieces of the recyclable material object;
c. a slidable carriage assembly adapted to receive the two or more pieces of the recyclable material object from the material compacting system; and
d. one or more cartridges adapted to receive the two or more pieces of the recyclable material object from the carriage assembly.

12. The machine according to claim 11, further comprising a system configured to slidably move the carriage assembly.

13. The machine according to claim 11, further comprising a system configured to slidably move the carriage assembly.

14. The machine according to claim 11, wherein the material compacting system comprises a shredder.

15. The machine according to claim 11, wherein the sensor system comprises a laser scanner and at least one camera.

16. A method for processing recyclable materials, comprising the steps of:
a. providing a machine comprising an input, a sensor system, a conveyor belt assembly configured to move a recyclable material object from the input to the sensor system and a material condensing system, a carriage assembly configured to move from alignment with the material condensing system to a position above a cartridge on a bottom surface of the machine, and a crypto-currency dispensing system;
b. depositing a recyclable material object into the input of the machine;
c. moving, via the conveyor belt assembly, the recyclable material object to the sensor system;
d. determining the identity of the recyclable material object;
e. moving, via the conveyor belt assembly, the recyclable material object to the material condensing system;
f. destructing, via the material condensing system, the recyclable material object into two or more pieces of the recyclable material object;
g. collecting the two or more pieces of the recyclable material object in the carriage assembly;
h. positioning the carriage assembly in alignment with the cartridge; and
i. depositing the two or more pieces of the recyclable material object into the cartridge.

17. The method of claim 16, further comprising the step of dispensing crypto-currency, via the crypto-currency dispensing system, in an amount corresponding to the identity of recyclable material object.

18. The method of claim 16, further comprising the step of weighing the recyclable material object via a scale in the conveyor belt assembly.

19. The method of claim 18, further comprising the step of dispensing, crypto-currency, crypto-currency dispensing system, in an amount corresponding to the identity of the recyclable material object and a weight of the recyclable material deposited determined via the scale.

20. The method of claim 16, wherein the step of positioning the carriage assembly in alignment with the cartridge comprises the step of slidably moving the carriage assembly along a rail system.
